(19) United States
(12) Patent Application Publication
(10) Pub. No.: US 2026/0319961 A1
(43) Pub. Date: Oct. 15, 2026

(54) Mechanisms for Invalidating Address Translations Cached in Memory Management Circuits

(71) Applicant: Apple Inc., Cupertino, CA (US)

(72) Inventors: Peter A. Lisherness, Los Gatos, CA (US); Roy G. Moss, Palo Alto, CA (US); Jeff Gonion, Campbell, CA (US); Bernard J. Semeria, Palo Alto, CA (US); James Vash, San Ramon, CA (US); Sergio Kolor, Haifa (IL)

(21) Appl. No.: 19/175,625

(22) Filed: Apr. 10, 2025

(51) Int. Cl. G06F 12/0891; G06F 12/1009

(52) U.S. Cl. CPC G06F 12/0891

(57) ABSTRACT

Techniques are disclosed relating to invalidating cached address translations. A system includes a processor complex, subsystems, and a communication fabric. The subsystems may include respective sets of memory management circuits that cache virtual-to-physical address translations of a set of page tables, and the processor complex includes one or more processor cores. Invalidation management circuitry of the communication fabric may receive, from a processor core of the processor complex, a write request having a translation invalidation payload. The invalidation management circuitry converts the write request into a translation invalidation request to invalidate one or more address translations and forwards the translation invalidation request on the communication fabric to one or more of the subsystems. The invalidation management circuitry receives, from those subsystems, translation invalidation responses indicating that the translation invalidation request has been completed. The invalidation management circuitry issues, to the processor core, a write response to the write request.

### BACKGROUND

### Technical Field

This disclosure relates generally to integrated circuits and, more specifically, to various mechanisms for invalidating address translations cached in memory management circuits.

### Description of the Related Art

Modern computer systems often include one or more SOCs (system on a chip) that each integrate many components (e.g., a central processing unit (CPU), a graphics processing unit (GPU), etc.) onto an integrated circuit die. These components are normally coupled to memory devices (e.g., random access memory) via memory controllers, and they perform read and write transactions that involve accessing the memory devices. For such transactions, the components may retrieve data from and/or write data to those memory devices based on memory addresses. Modern computer systems leverage virtual memory addresses instead of only physical memory addresses when accessing memory devices due to various benefits, such as process isolation, security, and efficient memory management. For example, virtual addressing allows a program to operate within its own isolated address space, preventing accidental/malicious interference between programs. When a program thus requests data from or writes data to a memory device, it can use a virtual memory address. The virtual memory address is translated into a physical memory address used to access the memory device. To speed up this translation, a component may locally cache virtual-to-physical memory address translations.

### BRIEF DESCRIPTION OF THE DRAWINGS

FIG. 1A is a block diagram illustrating one embodiment of a system having invalidation management circuitry that is configured to covert write requests into translation invalidation requests and translation invalidation responses into write responses.

FIG. 1B is a block diagram illustrating one embodiment of a system having invalidation management circuitry that is configured to broadcast data synchronization barrier requests.

FIG. 2 is a block diagram illustrating one embodiment of a communication fabric having the invalidation management circuitry.

FIG. 3 is a block diagram illustrating one embodiment of the invalidation management circuitry.

FIG. 4A is a block diagram illustrating one embodiment of a subsystem broadcasting a translation invalidation request to its memory management circuitry.

FIG. 4B is a block diagram illustrating one embodiment of a subsystem broadcasting a data synchronization barrier request to its memory management circuitry.

FIG. 5 is a diagram illustrating one embodiment of a process that involves invalidating virtual-to-physical address translations cached in memory management circuitry.

FIG. 6 is a block diagram illustrating one embodiment of power detection circuitry of a communication fabric responding on behalf of a subsystem.

FIGS. 7-9 are flow diagrams illustrating example methods that pertain to invalidating cached virtual-to-physical address translations.

FIG. 10 is a block diagram illustrating one embodiment of a device that implements components described in the present disclosure.

FIG. 11 is a block diagram illustrating a system that implements components described in the present disclosure being used in various types of applications.

FIG. 12 is a block diagram illustrating one embodiment of a process for fabricating an integrated circuit that implements components described in the present disclosure.

### DETAILED DESCRIPTION

Modern computer systems leverage virtual addressing to effectively read data from and write data to memory while also providing process isolation, security, and optimized resource management. When a program executing in a central processing unit (CPU) requests data from or writes data to main memory, it may use a virtual memory address that is translated by the CPU into a physical memory address in main memory. In particular, the CPU includes memory management circuitry (also referred to as a memory management unit (MMU)) that handles the translation of virtual addresses used by programs to the physical addresses in main memory where data is stored or being written. In order to speed up the translation process, the memory management circuitry can cache virtual-to-physical address translations from page tables that are used to control access to memory. A page of physical memory can be granted to a process or a hardware component and revoked when ownership of that page is transferred to another process or component. When the page is revoked (e.g., ownership is changed), the appropriate page table(s) are modified to remove or otherwise invalidate the relevant address translations. These translations are also invalidated in the hardware components (e.g., MMUs) that cache them.

In order to invalidate address translations cached in its memory management circuitry, a CPU processor executes translation lookaside buffer invalidate (TLBI) instructions and data synchronization barrier (DSB) instructions. TLBI instructions ensure that cached address translations are invalidated, while DSB instructions ensure that there are no transactions in flight that may have used the now-invalidated address translations. TLBI instructions executed by one CPU processor can result in TLBI commands/requests being sent to other processors to invalidate translations cached by those other processors. Such commands may encode a range of virtual addresses to invalidate and an address space identifier (ASID) that denotes which address space those virtual addresses belong to. In various systems, these commands/requests require a success acknowledgement response in order to complete the associated TLBI transaction. DSB instructions executed by a CPU processor can also result in transactions in which a request is issued to another processor and a corresponding success response is required in order to complete the transaction.

A system can also comprise various subsystems (e.g., a display subsystem, an encoder subsystem, etc.) outside of the CPU. These subsystems can include memory management circuitry that also caches address translations from the page tables. As with a CPU processor's memory management circuitry, cached address translations may be invalidated when changes are made to the page tables (e.g., the ownership of a page is changed). But the TLBI instructions that are used to ensure that cached address translations are invalidated within the CPU cannot, in many cases, be used to ensure that cached address translations are invalidated within the subsystems for various reasons. First, the memory management circuitry within certain subsystems may not use the ASIDs that are used by the CPU since the memory management circuitry may have its own, separate virtual address space. As a result, TLBI instructions that use ASIDs cannot be used for these subsystems. Second, TLBI instructions may allow only certain coarse address ranges to be invalidated. The coarse address ranges sometimes lead to over invalidation. This over invalidation may only cause decreased performance for a CPU processor but functional failure for certain memory management circuitry within certain subsystems. For example, the memory management circuit of a particular subsystem may cache address translations without a cache miss mechanism to retrieve a translation if it is not cached in the event of a cache miss. Accordingly, over invalidation can invalidate and remove translations that are expected to be cached. When the memory management circuitry attempts to access them, a functional failure will occur since the translations are not cached and the management circuitry does not have a cache miss mechanism to fetch them.

In order to ensure that cached address translations are invalidated within a subsystem, one approach is to use programmed input/output (PIO) write and read requests. When seeking to invalidate certain address translations cached in the memory management circuitry of a certain subsystem, a CPU processor can issue a PIO write request to the memory management circuitry to initiate a TLBI operation to invalidate those address translations. The processor then follows up the PIO write request with one or more PIO read requests to poll for completion. DSBs can also be handled by using another PIO write request to initiate a DSB operation and polling PIO read requests to poll for completion. While PIO requests permit precise invalidations of address ranges, they have drawbacks. First, PIO transactions (a PIO write request and one or more PIO read requests) can return an error (e.g., if the PIO's destination is inaccessible). In many cases, the errors are treated as non-recoverable and can cause the CPU to panic the system. Second, a CPU processor may have to issue multiple PIO read requests to poll for completion of a TLBI or DSB operation and PIO transactions may be serialized and thus the whole PIO sequence has to be performed for the memory management circuitry of each relevant subsystem, which can be very inefficient. This present disclosure addresses, among other things, the problem of how to invalidate address translations cached in the subsystems in a manner that overcomes one or more of the above deficiencies.

In various embodiments described below, a system includes a processor complex (that includes processor cores, or simply, processors), various subsystems, and a communication fabric that couples the processors and the subsystems together. One or more of the subsystems include memory management circuitry that caches virtual-to-physical address translations of a set of page tables. A processor may perform an update on the set of page tables. For example, the processor may modify a page table in main memory to invalidate a set of virtual-to-physical address translations as part of an ownership change of a physical memory page. After updating the set of page tables, the processor may then issue one or more write requests (e.g., PIO write requests) on the communication fabric to invalidate affected address translations that may be cached in the memory management circuitry of one or more subsystems. The processor may issue one write request per subsystem that is relevant to the affected address translations.

In various embodiments, the communication fabric includes invalidation management circuitry that intercepts the write requests, converts them into translation invalidation requests, and then forwards the translation invalidation requests on the communication fabric to the one or more subsystems as part of transactions in which a response must be returned. That is, for a given write request, the invalidation management circuitry may convert it into a translation invalidation request and forward the translation invalidation request to the relevant subsystem. The translation invalidation request may include information from the write request, such as its payload that identifies the address range(s) to invalidate.

The one or more subsystems may each receive an translation invalidation request. In various embodiments, the local fabric of a subsystem broadcasts the translation invalidation request to the memory management circuitry (all MMUs) within the subsystem. The memory management circuitry may invalidate affected address translations (if cached), and a translation invalidation response is returned by the subsystem to the invalidation management circuitry that indicates that the translation invalidation request has been completed. The invalidation management circuitry receives the translation invalidation response and then returns a write response to the processor for the write request associated with that subsystem. Accordingly, the invalidation management circuitry may receive, from each of the one or more subsystems, a translation invalidation response that indicates that a translation invalidation request has been completed and issue a write response to the processor for the associated write request.

After the affected address translations have been invalidated, the processor may initiate a DSB operation. Instead of the processor issuing a write request to initiate the DSB operation, in various embodiments, the processor issues a DSB request on the communication fabric that initiates the DSB operation. The invalidation management circuitry receives the DSB operation and may broadcast the DSB request to the relevant subsystems. The invalidation management circuitry may track which subsystems have received a translation invalidation request since the last DSB request was issued by any processor of the processor complex and broadcast the DSB request to only those subsystems. The subsystems may process the DSB request and return a DSB response to the invalidation management circuitry. Once the invalidation management circuitry has received a DSB response from all relevant subsystems, in various embodiments, the invalidation management circuitry returns a single DSB response to the processor for the DSB request.

These techniques may be advantageous over prior approaches for various reasons. First, by allowing a processor to initiate a TLBI operation using a PIO write request, these techniques avoid overloading the architecturally defined CPU TLBI operation. The CPU TLBI operation does not have to be modified to account for memory management circuitry residing in certain subsystem outside of the CPU (e.g., the CPU TLBI operation does not have to be modified to account for the memory management circuitry that does not use the ASIDs that are used by the CPU). Second, by converting the write request into a translation invalidation request that is a part of a transaction in which a response must be returned, these techniques allow for precise, arbitrary address range invalidation while also breaking the dependency on PIO read and write requests for a portion of the system (particularly, the communication fabric). For example, since a response must be returned for the transaction, neither the processor, nor the communication fabric, has to continually poll the memory management circuitry of a subsystem using multiple PIO read requests to determine if the address translations have been invalidated. Third, since these polling read PIOs can be eliminated, translation invalidation requests can be pipelined, sending as many as desired. Fourth, by tracking which subsystems received a translation invalidation request since the last DSB request issued by a processor, the invalidation management circuitry can selectively broadcast a DSB request from a processor to only those subsystems instead of the total set of subsystems, which conserves power and resources in the system.

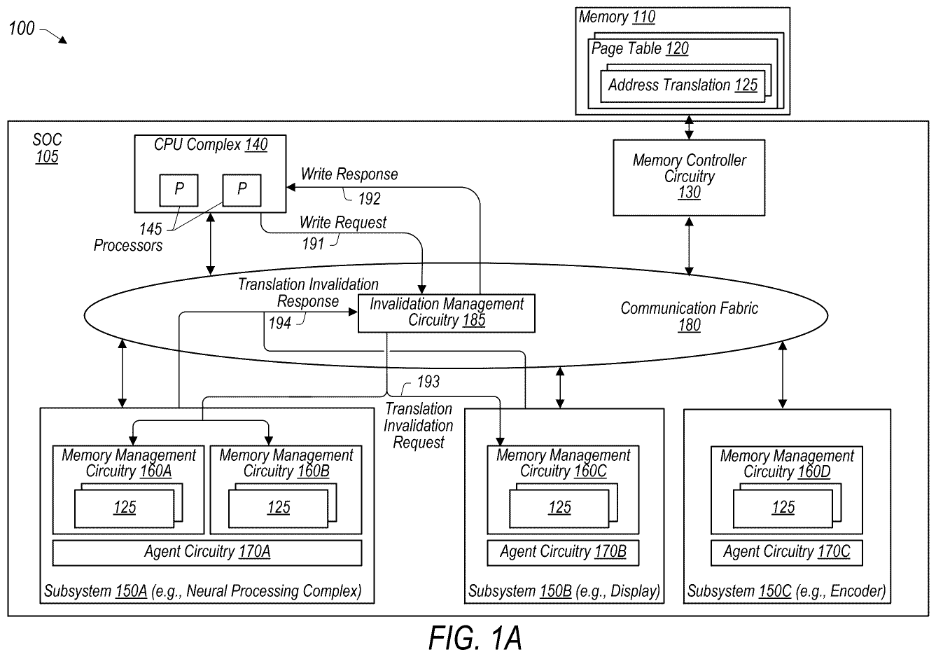

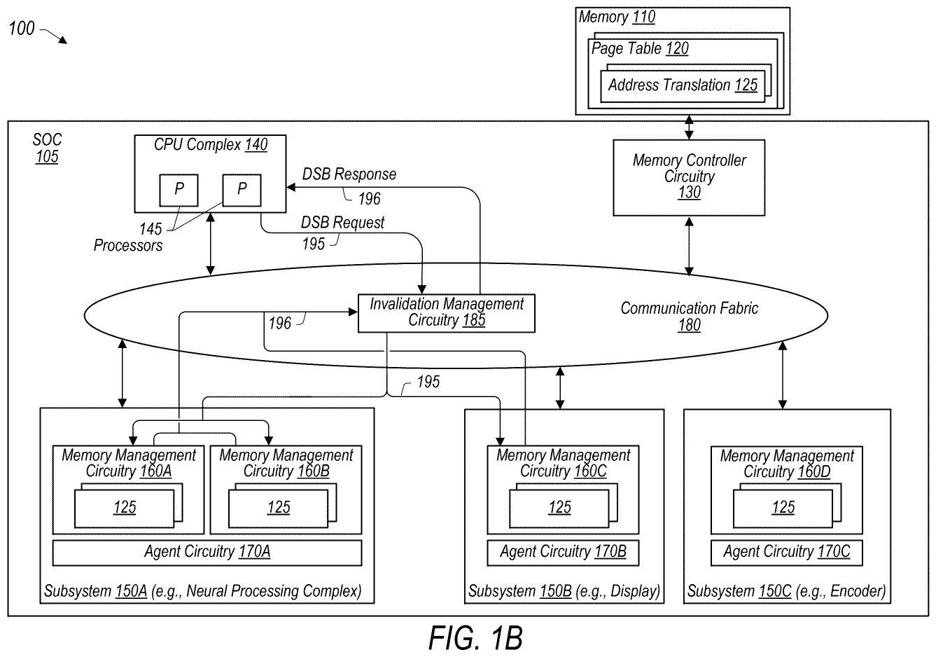

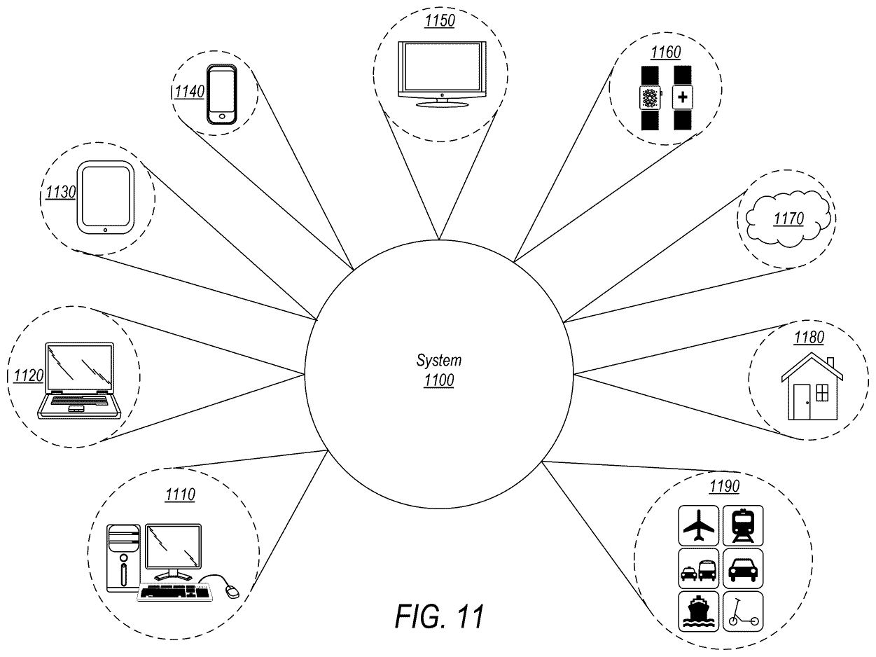

Turning now to FIG. 1A, a block diagram of one embodiment of a system 100 is shown. System 100 may be any type of hardware-based system, such as a desktop computer, a laptop computer, a tablet computer, a cellular or mobile phone or device, etc. Examples of different types of systems that can correspond to system 100 are discussed in greater detail with respect to FIG. 11. In the illustrated embodiment, system 100 includes an SOC 105 that is coupled to a memory 110. As shown, SOC 105 includes memory controller circuitry 130, a CPU complex 140, and subsystems 150A-C, all of which are coupled to a communication fabric 180. Also as shown, memory 110 is coupled to memory controller circuitry 130 and includes page tables 120 having address translations 125 (also referred to as virtual-to-physical address translations 125). CPU complex 140 includes processors 145 (alternatively referred to as processor cores 145), subsystems 150A-C include agent circuitry 170A-C, respectively, and communication fabric 180 includes invalidation management circuitry 185. As further shown, subsystem 150A includes memory management circuitry 160A and 160B, subsystem 150B includes memory management circuitry 160C, and subsystem 150C includes memory management circuitry 160D.

The illustrated embodiment may be implemented differently shown. For example, SOC 105 may include multiple instances of memory controller circuitry 130, each of which may be coupled to memory 110 or their own memory 110. Accordingly, it is noted that the number of components of system 100 (and/or the number of subcomponents shown in FIG. 1A) may vary between embodiments. Thus, there can be more or fewer of each component or subcomponent than the number shown in FIG. 1A.

SOC 105 in various embodiments, integrates various components (e.g., CPU complex 140, subsystems 150A-C, etc.) onto a single semiconductor substrate as an integrated circuit chip and hence is referred to as a system on a chip (SOC). In some embodiments, however, the components are implemented on two or more discrete chips that are coupled together in system 100. For the ease of discussion, various embodiments in this disclosure are described as being implemented using one or more SOCs. But it is to be understood that any disclosed SOC can also be implemented using a chiplet-based architecture. Wherever the term “SOC” appears in this disclosure, the references are intended to suggest alternate embodiments in which the same functionality is implemented via a less monolithic architecture such as using multiple dies that can be included in a single integrated assembly package in some embodiments.

Architectures in which there are multiple dies are to be understood to encompass both homogeneous designs (in which each die includes identical or almost identical functionality) and heterogeneous designs (in which the functionality of each die diverges more considerably). This disclosure further contemplates embodiments in which the functionality of multiple SoCs are implemented using different levels of discreteness. For example, the functionality of a first system could be implemented on a single IC, while the functionality of a second system (which could be the same or different than the first system) could be implemented using a number of co-packaged dies/chiplets. While subsystems 150A-C are shown as part of the same SOC 105, in various embodiments, subsystems 150A-C may be located on different dies that are included in an integrated assembly package.

Memory 110, in various embodiments, is usable to store data and program instructions that are executable by components of SOC 105 (e.g., CPU complex 140) to cause system 100 to implement operations as described herein. Memory 110 can be implemented using different physical memory media, such as hard disk storage, floppy disk storage, removable disk storage, flash memory, random access memory (RAM—SRAM, EDO RAM, SDRAM, DRAM, etc.), read only memory (PROM, EEPROM, etc.), etc. But the memory that is available to SOC 105 is not limited to memory 110. Rather, SOC 105 may include other forms of storage such as a memory cache within memory controller circuitry 130 and/or cache memory (e.g., L1 cache, L2 cache, etc.) within other components (e.g., CPU complex 140) of SOC 105. As shown in FIG. 1A, memory 110 is used to store page tables 120.

A page table 120, in various embodiments, is a data structure that is used to map virtual memory addresses to physical memory addresses. As shown, there can be multiple page tables 120, each of which may be assigned to one or more computer processes—e.g., each computer process can have its own dedicated page table 120. Page tables 120 may be set up and managed by an operating system implemented by system 100, and may be organized hierarchically (e.g., multi-level page tables 120) to save space and improve performance. An entry in a page table 120 may map a virtual page (used by a process) to a physical page in memory 110. In various embodiments, an entry of a page table 120 can include a physical frame number that points to the physical page frame in memory 110 where the data resides, status flags (e.g., present, dirty, cached, etc.), and access permissions (e.g., whether it is writable). But the size and format of an entry can vary depending on the architecture of system 100 and the operating system used. An address translation 125, in various embodiments, corresponds to a portion or all of an entry in a page table 120. As discussed throughout this disclosure, memory management circuitry 160 throughout system 100 may cache address translations 125 from page tables 120 (that is, cache entries of page tables 120) and use them to translate virtual addresses used by processes to physical addresses in memory 110.

Memory controller circuitry 130, in various embodiments, includes circuitry that is configured to receive, from the other components of SOC 105, memory requests (e.g., load and store requests, instruction fetch requests, etc.) to perform memory operations, and circuitry configured to access memory 110 to complete those memory operations. Memory controller circuitry 130 may be configured to access any type of memory 110. In various embodiments, memory controller circuitry 130 includes queues for storing memory operations, for ordering (and potentially reordering) them, and presenting them to memory 110. Memory controller circuitry 130 may also include data buffers to store write data awaiting to be written to memory 110 and read data awaiting to be returned to the source of a memory operation/request, such as a processor 145 of CPU complex 140.

CPU complex 140, in various embodiments, includes a set of processors 145 that serve as a CPU of SOC 105. A processor 145 may include any circuitry or microcode configured to execute instructions that are defined in an instruction set architecture that is implemented by the processor 145. Processors 145 may encompass discrete microprocessors, processors and/or microprocessors integrated into multichip module implementations, processors implemented as multiple integrated circuits, etc. Also, CPU complex 140 can include a single processor 145, multiple processors 145 (e.g., 16, 24, etc.), or clusters of processors 145 (e.g., a power efficient cluster and a high performance cluster). Processors 145 may execute the main control software of the system, such as an operating system. Generally, software executed by processors 145 during use controls the other components of system 100 to realize the desired functionality of system 100. Processors 145 may also execute other software, such as application programs. An application program may provide user functionality and rely on the operating system for lower-level device control, scheduling, memory management, etc. Processors 145 can thus be referred to as application processors.

CPU complex 140 may include other hardware such as an L2 cache and/or an interface to other components of system 100 (e.g. an interface to communication fabric 180). In various embodiments, processors 145 of CPU complex 140 share a common last level cache (e.g., an L2 cache) while including their own caches (e.g., an L0 cache, an L1 cache, etc.) for storing instructions and data. A processor 145 may fetch instructions and data from memory 110 as a part of executing load instructions and store the fetched instructions and data in caches of CPU complex 140. The processor 145 may retrieve the instructions and data (e.g., from the caches) and execute the instructions to perform operations involving the data. The processor 145 may then write a result of the operations back to memory 110.

As part of executing the operating system, a processor 145 may modify page tables 120 in memory 110. In some cases, a page table 120 is modified to revoke a process's or hardware component's access to a physical memory page. For example, to revoke memory management circuitry 160A's access to a page of memory 110, a page table 120 may be modified to remove or otherwise invalidate the relevant address translations 125. A page table 120 may be modified for other reasons. A page table 120 may be modified to handle page faults, deallocate memory (e.g., when a process frees memory), facilitate context switches, address hardware or software errors, and address memory protection violations. When a processor 145 modifies a page table 120, in various embodiments, it has to ensure that the effects of the modification are realized and accounted for by other components in system 100.

In order to ensure that the effects are realized, in various embodiments, a processor 145 executes write instructions, TLBI instructions, and DSB instructions. Write instructions and TLBI instructions may ensure that any relevant, cached address translations are invalidated, and the DSB instructions may ensure that there are no transactions in flight that may have used the now-invalidated address translations. In various embodiments, TLBI instructions executed by a processor 145 result in TLBI commands/requests being issued to other processors 145 to invalidate address translations 125 cached by those other processors 145, and write instructions (which are being used to initiate TLBI operations) that are executed by a processor 145 result in write requests 191 being issued to components (e.g., subsystems 150A-C) outside of CPU complex 140. DSB instructions executed by a processor 145 result in DSB commands/request being issued to other processors 145 and/or components outside of CPU complex to complete outstanding/in-flight transactions that may have used invalidated address translations 125. In various cases, a DSB instruction is executed after executing one or more write and/or TLBI instructions that result in cached address translations 125 being invalidated.

Subsystems 150, in various embodiments, are sets of additional hardware functionality included in SOC 105. As an example, subsystems 150 may include video-related subsystems, such as graphics processing units (GPUs), video encoder/decoders, scalers, rotators, blenders, display controllers, etc. Subsystems 150 may further include audio-related subsystems, such as microphones, speakers, interfaces to microphones and speakers, audio processors, digital signal processors, mixers, etc. Subsystems 150 may include interface controllers for interfaces external to SOC 105, such as Universal Serial Bus (USB), peripheral component interconnect (PCI) including PCI Express (PCIe), serial and parallel ports, etc. Subsystems 150 may include networking-related subsystems and neural processing complexes/units. As shown, subsystems 150A-C include respective agent circuitry 170A-C.

Agent circuitry 170, in various embodiments, provides functionality of its subsystem 150. For example, if subsystem 150A is a neural processing complex, then agent circuitry 170A may include a set of neural processors. As another example, if subsystem 150C is a decoder, then agent circuitry 170C may include circuitry for decoding video data according to different video compression standards (e.g., advanced video coding, high efficiency video coding, VP9, etc.). Also, subsystems 150A-C can be referred to as agents. As used herein, an agent is any component or device (e.g., processors 145, subsystems 150A-C, etc.) that sources and/or sinks communications on networks of system 100 (e.g., communication fabric 180). A source agent circuit generates (sources) a communication and a destination agent circuit receives (sinks) the communication. An agent may be a source agent for some communications and a destination agent for other communications.

Memory management circuitry 160, in various embodiments, is circuitry configured to provide address translations for instruction fetch addresses and load/store addresses that can be received from its agent circuitry 170. Memory management circuitry 160 may include one or more translation lookaside buffers (TLBs), as well as table walk circuitry that performs the translation table reads to obtain a translation 125 for an address that misses in the TLBs. If a particular address translation 125 is not cached, then memory management circuitry 160 may fetch it from a page table 120 in memory 110. In some cases, memory management circuitry 160 does not include table walk circuitry but instead relies on specific instructions to fetch and cache address translations 125. As an example, memory management circuitry 160C may be a streaming MMU that handles memory access patterns typical in data streaming applications, such as video processing. Streaming MMUs may not include table walk circuitry.

Communication fabric 180, in various embodiments, is an interconnect that facilitates communication among the components of SOC 105. For example, communication fabric 180 can enable a processor 145 to send a memory request to memory controller circuitry 130 for data stored at memory 110 and subsequently receive the data. Communication fabric 180 may implement any type of communication interconnect and protocol for communicating among components coupled to fabric 180. In some embodiments, communication fabric 180 is bus-based, including shared bus configurations, cross bar configurations, and hierarchical buses with bridges. Communication fabric 180 may be packet-based and hierarchical with bridges, cross bar, point-to-point, or other interconnects. In some embodiments, communication fabric 180 implements a ring topology in which its network switches form a ring so that any network switch may reach any other network switch in the ring by transmitting a communication on the ring in the direction of the other network switch. Communication fabric 180 may implement a double ring topology in which there are multiple communication paths (e.g., one path used to send requests in a clockwise direction among components of SOC 105 and another path that is used to send requests in a counterclockwise direction). The term “communication fabric” can be used interchangeably with the term “communication network.”

While not depicted in FIG. 1A, communications fabric 180 can be connected to another communication fabric on another die via a die-to-die (D2D) interface. The D2D interface may extend the networks and the buses of dies between dies such that those networks and buses can function as a single unified fabric topology connecting dies together. The D2D interface may include various signals that are asserted/driven by sender blocks on one die and received by a corresponding receiver blocks on another die. Communications fabrics can be connected via a general-purpose input/output (GPIO) interface that includes a set of signal pins on one die that are connected to a corresponding set of signal pins on another die. Those signal pins may be set up to accept or source different logic voltages and thus can be used to perform digital input and output functions. By being connected via one or more interfaces, communications fabrics may permit components of one die (e.g., CPU complex 140) to issue requests to read and/or write data at a memory coupled to another die).

Invalidation management circuitry 185, in various embodiments, includes circuitry that is configured to detect a write request 191 from a processor 145 to a subsystem 150 (or memory management circuitry 160), convert it into a translation invalidation request 193, and route that translation invalidation request 193 to its destination. Invalidation management circuitry 185 includes circuitry configured to detect a translation invalidation response 194 from a subsystem 150 to a processor 145, convert it into a write response 192, and route that write response 192 to its destination. Invalidation management circuitry 185 may also include circuitry configured to process DSB requests from processors 145 and DSB responses from subsystem 150.

As discussed, a processor 145 may execute instructions that result in changes to one or more page tables 120, and the processor 145 may execute additional instructions to ensure that the effects of those changes are realized and accounted for by other components in system 100. For example, address translations 125 of page tables 120 associated with memory management circuitry 160A and 160C may be invalidated. Those address translations 125 might be cached by memory management circuitry 160A and 160C. Consequently, a processor 145 may issue a set of write requests 191 to cause memory management circuitry 160A and 160C to invalidate those address translations 125 if they are cached in a valid state. The number of write requests 191 that are issued may vary between embodiments—e.g., one write request 191 per subsystem 150, one write request 191 per memory management circuitry 160, one write request 191 per multiple subsystems 150, etc.

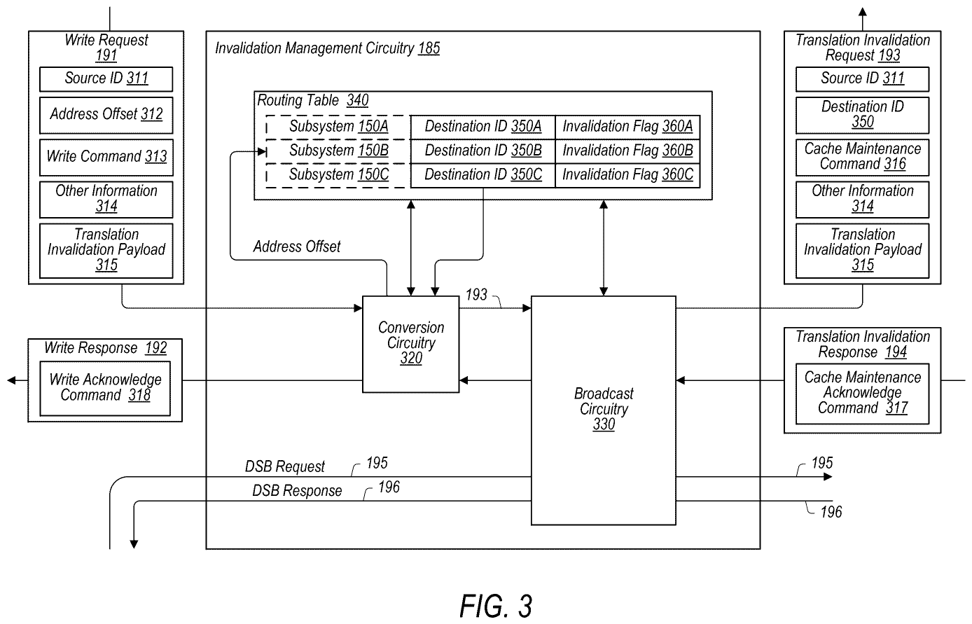

The set of write requests 191 is detected by invalidation management circuitry 185 and converted into a set of translation invalidation requests 193. As an example, two write requests 191 may be received that are directed to subsystems 150A and 150B. Invalidation management circuitry 185 may convert the write requests 191 into two translation invalidation requests 193 and forward them on communication fabric 180 to subsystems 150A and 150B. Write requests 191, translation invalidation requests 193, and the conversion process are discussed in greater detail with respect to FIG. 3.

The translation invalidation requests 193 are received by subsystems 150A and 150B. In various embodiments, a local communication fabric of subsystems 150A and 150B routes the translation invalidation requests 193 to the memory management circuitry 160 within those subsystems. As shown in FIG. 1A, translation invalidation requests 193 are routed to memory management circuitry 160A-C. Memory management circuitry 160A-C may determine if the received translation invalidation request 193 is relevant to them, and if so, then invalidate any relevant, cached address translations 125. Translation invalidation responses 194 are returned from subsystems 150A and 150B to invalidation management circuitry 185 for the respective translation invalidation requests 193. Invalidation management circuitry 185 may then convert those translation invalidation responses 194 into respective write responses 192 and forward them to the appropriate processor 145, completing the write transactions that were initiated by that processor 145.

Turning now to FIG. 1B, a block diagram of one embodiment of system 100 in which invalidation management circuitry 185 broadcasts DSB requests 195 to subsystem 150A-C is shown. In the illustrated embodiment, system 100 includes SOC 105 coupled to memory 110. Also as shown, SOC 105 includes memory controller circuitry 130, CPU complex 140, and subsystems 150A-C, all of which are coupled to communication fabric 180. As further shown, memory 110 is coupled to memory controller circuitry 130 and includes page tables 120 having address translations 125. CPU complex 140 includes processors, subsystems 150A-C include agent circuitry 170A-C, respectively, and communication fabric 180 includes invalidation management circuitry 185. As further shown, subsystem 150A includes memory management circuitry 160A and 160B, subsystem 150B includes memory management circuitry 160C, and subsystem 150C includes memory management circuitry 160D.

As discussed, a processor 145 can execute a DSB instruction. Broadly speaking, a DSB instruction is considered a type of synchronizing instruction (also referred to as a “barrier” or “fence” instruction) that enables multiple components in system 100 to share a consistent and coherent view of shared memory (e.g., in order to avoid race conditions or other situations in which a component's view of memory contents is dependent upon the possibly unpredictable order in which memory operations are completed). Strong types of synchronizing instructions typically treat all the outstanding load/store operations as equivalent in their potential to visibly affect memory state. By requiring all such operations to complete before processing is allowed to continue, strong synchronizing instructions provide maximal assurance regarding memory assurance at the potential expense of performance.

In various embodiments, invalidation management circuitry 185 includes circuitry that is configured to detect a DSB request 195 from a processor 145 and broadcast that DSB request 195 to one or more subsystems 150 of system 100. As discussed in greater detail with respect to FIG. 3, invalidation management circuitry 185 may track which subsystems 150 received at least one translation invalidation request 193 since the last DSB request 195 and broadcast the received DSB request 195 to only those subsystems 150. In the example discussed with respect to FIG. 1A, subsystems 150A and 150B received a translation invalidation request 193 and thus invalidation management circuitry 185 may send the illustrated DSB request 195 to subsystems 150A and 150B. In various embodiments, if no translation invalidation requests 193 were sent to subsystems 150 since the last DSB request 195, then invalidation management circuitry 185 returns a DSB response 196 to the appropriate processor 145 that acknowledges that the DSB operation has been completed.

As shown, the illustrated DSB request 195 is received by subsystems 150A and 150B and routed to memory management circuitry 160A-C. Memory management circuitry 160A-C may then process the request, which can involve ensuring there are no transactions in flight that may have used the address translations 125 that were invalidated as a result of translation invalidation requests 193. DSB responses 196 are returned from subsystems 150A and 150B to invalidation management circuitry 185. In various embodiments, invalidation management circuitry 185 collects DSB responses 196 from all relevant subsystems 150 before providing a DSB response 196 to the appropriate processor 145. Thus, after receiving DSB responses 196 from subsystems 150A and 150B, invalidation management circuitry 185 may provide a DSB response 196 to the appropriate processor 145, completing the DSB transaction for subsystems 150A and 150B. In various cases, invalidation management circuitry 185 may receive DSB requests 195 in a particular order from multiple processors 145 or even the same processor 145. Invalidation management circuitry 185 may return DSB responses 196 to the processor(s) 145 in the same order in which the DSB requests 195 were received.

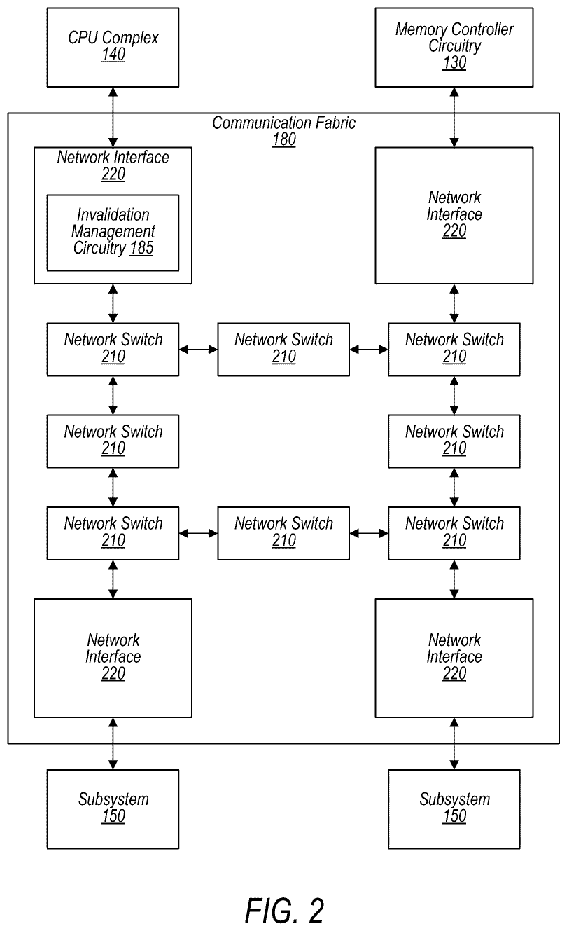

Turning now to FIG. 2, a block diagram of one embodiment of communication fabric 180 is shown. In the illustrated embodiment, there is memory controller circuitry 130, CPU complex 140, and two subsystems 150, all of which are coupled together via communication fabric 180. As shown, communication fabric 180 includes multiple network interfaces 220 that are coupled to network switches 210 that form a ring. As further shown, the network interface 220 that is coupled to CPU complex 140 includes invalidation management circuitry 185. The illustrated embodiment may be implemented differently than shown. As an example, network switches 210 may form a mesh, a double ring, etc., there can be more or fewer subsystems 150 coupled to communication fabric 180, and/or communication fabric 180 may be coupled to a different communication fabric located on another die in a multi-die architecture.

A network switch 210, in various embodiments, is circuitry that is configured to receive communications on a network and forward the communications on the network in the direction of the destination of the communication. For example, a packet sourced by a processor 145 of CPU complex 140 may be forwarded by network switches 210 to memory controller circuitry 130 in order to access memory 110. A packet may be a command packet having a command without accompanying data or a command-data packet having a command and accompanying data. Packets may include an indication of a virtual channel and a subchannel that a packet is travelling in, a memory address, source and destination agent identifiers, data (if appropriate), etc. For example, as discussed in more detail with respect to FIG. 3, a write request 191 can be issued as a command-data packet that includes a translation invalidation payload and identifies a source identifier, an address offset, and other information.

Multiple packets may form a transaction. A transaction, in various embodiments, is a complete communication between a source agent (e.g., a processor 145 of CPU complex 140) and a target agent (e.g., memory controller circuitry 130). For example, a DSB transaction may include a DSB request 195 from the source agent (e.g., a processor 145 of CPU complex 140) to the target agent (e.g., another processor 145) and a DSB response 196 from the target agent to the source agent. As another example, a write transaction may include a write request 191 from the source agent to the target agent, possibly one or more coherence message packets if the transaction is coherent, and a write response 192 from the target agent to the source agent. In a similar manner, a read transaction may include a read request packet from the source agent to the target agent, one or more coherence message packets if the transaction is coherent, and a data response packet from the target agent to the source agent. Also, as another example, a translation invalidation transaction (referred to as a TLBI cache maintenance transaction) may include a translation invalidation request 193 from invalidation management circuitry 185 to a target agent (e.g., a subsystem 150) and a translation invalidation response 194 from the target agent back to invalidation management circuitry 185.

Network switches 210 can form different topologies. In the illustrated embodiment, network switches 210 form a ring in which each network switch 210 is connected to two other network switches 210 such that any network switch 210 may reach any other network switch 210 in the ring by transmitting a communication (e.g., a packet) in the direction of the other network switch 210. A communication may pass through one or more intermediate network switches 210 in the ring to reach the targeted network switch 210. When a network switch 210 receives a communication from an adjacent network switch 210, the network switch 210 may examine the communication to determine if a component (e.g., a subsystem 150) to which the network switch 210 is coupled is the destination of that communication. If so, then the network switch 210 may forward the communication to the component (e.g., via the network interface 220 that is coupled to that component). If not, then the network switch 210 may forward the communication to the next network switch 210 (i.e., the other network switch 210 adjacent to the network switch 210 and not the network switch 210 from which the communication was received).

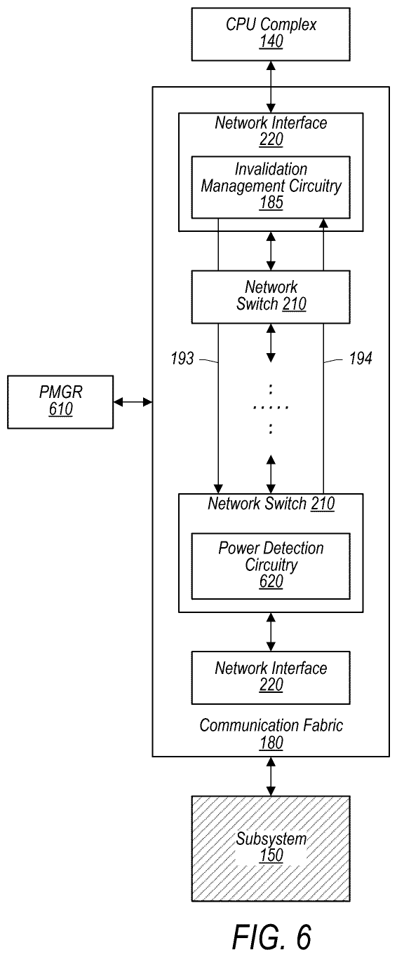

Accordingly, when invalidation management circuitry 185 issues a request (e.g., a DSB request 195) to a subsystem 150 (for example), in various embodiments, the request traverses around the ring (by being transmitted by network switches 210) until it reaches the subsystem 150, a fabric component that can respond on behalf of the subsystem 150 (as discussed in more detail with respect to FIG. 6), or it is transmitted to another network (e.g., another fabric, which may be a part of another die). In the illustrated embodiment, the ring is bi-directional and thus a request and a response may traverse the same network switches 210. But the ring may be unidirectional. In some embodiments, network switches 210 form two rings: one that allows for packets to traverse counterclockwise and another that allows for packets to traverse clockwise.

A network interface 220, in various embodiments, is circuitry configured to bridge a component (e.g., CPU complex 140) to communication fabric 180. A network interface 220 may include serializer/reserialized (SERDES) circuits that can be used to communicate across the boundary between communication fabric 180 and the component. Accordingly, while not shown in FIG. 2, a network interface 220 may be included in the component that is coupled to a network interface 220 on fabric 180. A network interface 220 may include sufficient routing storage (e.g., queues) and logic (e.g., an arbitration circuit) for managing the routing of requests and responses. Thus, as a component coupled to a network interface 220 issues requests and/or responses to the network interface 220, the network interface 220 may arbitrate among them to select ones to provide to the network switch 210 coupled to that network interface 220.

In the illustrated embodiment, invalidation management circuitry 185 is located in the network interface 220 that is coupled to CPU complex 140. Invalidation management circuitry 185 may be located in this network interface 220 since the network interface 220 may remain powered on when CPU complex 140 is powered on and thus invalidation management circuitry may remain powered on when CPU complex 140 is powered on. Moreover, all write requests 191 and DSB requests 195 from processors 145 of CPU complex 140 may travel through that network interface 220, and thus invalidation management circuitry 185 may be located there in order to ensure it is able to intercept those write requests 191 and DSB requests 195. But in other embodiments, invalidation management circuitry 185 is located elsewhere, such as at a PIO gateway.

In various embodiments, CPU complex 140 and the network interface 220 that includes invalidation management circuitry 185 are part of the same power domain. Generally, a power domain is configured to receive a supply voltage (i.e. be powered on) or not receive a supply voltage (i.e. be powered off) independent of other power domains. A component (e.g., memory controller circuitry 130, CPU complex 140, subsystems 150, etc.) can be referred to as powered on or powered off. A component is powered on if it is receiving a supply voltage so that it can operate as designed and powered off if it is not receiving that supply voltage and is not in operation. The component can be referred to as powered up if it is powered on, and powered down if it is powered off. Powering up a component refers to supplying the supply voltage to a component that is powered off, and powering down the component refers to terminating the supply of the supply voltage to that component. Also, any subcomponent and/or SOC 105 as a whole can be referred to as powered up/down, etc. Because the network interface 220 is in the same power domain as CPU complex 140 in various embodiments, it remains powered on when CPU complex 140 is powered on, and therefore invalidation management circuitry 185 remains powered on when CPU complex 140 is powered on.

Turning now to FIG. 3, a block diagram of one embodiment of invalidation management circuitry 185 is shown. In the illustrated embodiment, invalidation management circuitry 185 includes conversion circuitry 320, broadcast circuitry 330, and a routing table 340. As further shown, routing table 340 includes destination IDs 350A-C and invalidation flags 360A-C that correspond to subsystems 150A-C, respectively—subsystems 150A-C are depicted in dashed boxes within routing table 340 in order to show the subsystems to which IDs 350A-C and flags 360A-C correspond; the dashed boxes may not represent information stored in routing table 340. The illustrated embodiment may be implemented differently than shown. For example, routing table 340 may not include invalidation flags 360A-C.

As discussed, in response to invalidating address translations 125 in page tables 120, a processor 145 may issue a set of write requests 191 to particular subsystems 150 to invalidate corresponding cached address translations 125, which may be cached by memory management circuitry 160 of those subsystems 150. Accordingly, as shown, a write request 191 is received at invalidation management circuitry 185, particularly at conversion circuitry 320. In various embodiments, write request 191 is sent as a command-data packet. The command portion of the packet may identify a source ID 311, an address offset 312, and other information 314, and the data portion of the packet may include a translation invalidation payload 315.

Source ID 311, in various embodiments, is an identifier that identifies an endpoint (on communication fabric 180) from which write request 191 originated. Source ID 311 may thus identify an endpoint on communication fabric 180 that corresponds to CPU complex 140 in the case that write request 191 originates from a processor 145. In some embodiments, source ID 311 identifies the hardware component from which write request 191 originates. Thus, in the event that write request 191 originates from a processor 145, source ID 311 may identify that particular processor 145. While not shown in FIG. 3, a write response 192 and a translation invalidation response 194 may specify a source ID 311. As an example, the source ID 311 of a translation invalidation response 194 may identify an endpoint on communication fabric 180 that corresponds to a subsystem 150 (or a fabric component that is responding on behalf of that subsystem 150, as discussed in more detail with respect to FIG. 6).

Address offset 312, in various embodiments, is an offset/address in an address space that maps subsystems 150 to addresses of the address space. As shown, address offset 312 is used to index into routing table 340 to determine an destination ID 350 of the subsystem 150 being targeted by write request 191. In some embodiments, write request 191 may specify more than one address offset 312 in order to target multiple subsystems 150. Further, instead of specifying address offset 312, write request 191 may identify the subsystem(s) 150 (e.g., subsystem IDs), destination IDs 350, or other information that can be used to route the corresponding translation invalidation request 193 to those subsystems 150.

In various embodiments, write command 313 indicates that the request is initiating a write operation—the request is part of a write transaction. Other information 314 may specify a transaction ID, a size of the request, a virtual channel, a subchannel within the virtual channel, and a number of data beats. Other information 314 of write request 191 may be different than other information 314 of translation invalidation request 193. For example, other information 314 of translation invalidation request 193 may also specify the type of the cache maintenance command (e.g., TLBI).

Translation invalidation payload 315, in various embodiments, comprises information used to identify the address translations 125 to invalidate. For example, translation invalidation payload 315 may specify a range of virtual addresses and an address space to which the virtual address belong. Payload 315 may specify an address space identifier for the address space that is used by a subsystem's memory management circuitry 160 to perform an initial determination on whether the range of virtual addresses are even relevant to address translations 125 cached by that memory management circuitry 160.

Conversion circuitry 320, in various embodiments, includes circuitry that is configured to covert write request 191 into translation invalidation request 193 and translation invalidation response 194 into write response 192. In various embodiments, before converting write request 191 into translation invalidation request 193, conversion circuitry 320 first determines whether write request 191 should be converted. In particular, if address offset 312 matches a subsystem entry in routing table 340, then write request 191 may be converted into translation invalidation request 193, otherwise, it may not be converted.

As part of the conversion, in various embodiments, conversion circuitry 320 generates translation invalidation request 193 based on information of write request 191. For example, as shown, translation invalidation request 193 includes source ID 311, other information 314 (although portions of it may change), and translation invalidation payload 315. But instead of using address offset 312, conversion circuitry 320 includes, in translation invalidation request 193, the destination ID 350 corresponding to the subsystem 150 targeted by write request 191. For example, if address offset 312 indexes into the second entry of table 340 that corresponds to subsystem 150B, then translation invalidation request 193 specifies destination ID 350B. A destination ID 350, in various embodiments, identifies an endpoint on communication fabric 180. Accordingly, continuing the previous example, translation invalidation request 193 may be routed to an endpoint associated with subsystem 150B. That is, communication fabric 180 may be responsible for routing translation invalidation request 193 to the endpoint according to the destination ID 350. Subsequent routing beyond the endpoint, such as within subsystem 150B, may be the responsibility of the local fabric (e.g., the fabric within subsystem 150B). In some embodiments, a destination ID 350 identifies the targeted hardware component (e.g., the targeted subsystem 150) as opposed to an endpoint on communication fabric 180. In various embodiments, cache maintenance command 316 indicates that the request is initiating a cache maintenance operation (e.g., a TLBI).

In various embodiments, conversion circuitry 320 also sets an invalidation flag 360 as part of the process. An invalidation flag 360, in various embodiments, is a value that is used to indicate whether at least one translation invalidation request 193 has been sent to a subsystem 150 (mapped to that invalidation flag 360) since the most recent DSB request 195 was issued by a processor 145. That is, invalidation management circuitry 185 may use invalidation flags 360 to track which subsystems 150 have received at least one translation invalidation request 193 since the most recent DSB request 195 (or particularly, since the last DSB operation was performed). Continuing the previous example above, conversion circuitry 320 sets invalidation flag 360B associated with subsystem 150B (e.g., to 1). After generating translation invalidation request 193, conversion circuitry 320 provides it to broadcast circuitry 330.

Broadcast circuitry 330, in various embodiments, includes circuitry that is configured to forward requests on communication fabric 180 or broadcast them in the event that there are multiple recipients. For example, as shown, broadcast circuitry 330 receives DSB request 195; DSB request 195 may bypass conversion circuitry 320 as it may not have to be converted. DSB request 195 may not specify a destination. Instead, broadcast circuitry 330 may access routing table 340 to determine, based on invalidation flags 360, which subsystems 150 have received at least one translation invalidation request 193. In various embodiments, broadcast circuitry 330 broadcasts DSB request 195 to those subsystems 150 whose invalidation flag 360 has been set. Broadcast circuitry 330 may then clear the appropriate invalidation flags 360 (e.g., to 0). In some embodiments, broadcast circuitry 330 clears a subsystem's invalidation flag 360 after receiving a DSB response 196 from that subsystem 150.

As shown, broadcast circuitry 330 receives translation invalidation response 194. This response may be received from the subsystem 150 that received translation invalidation request 193. Cache maintain acknowledgement command 317, in various embodiments, indicates that translation invalidation response 194 is a completion acknowledgement to invalidation request 193. Broadcast circuitry 330 then provides translation invalidation response 194 to conversion circuitry 320, and conversion circuitry 320 converts it into write response 192 and forwards write response 192 to its destination (e.g., a processor 145). Write acknowledgment command 318 indicates that write response 192 is a completion acknowledgement to write request 191 (the write operation has been performed). Also as shown, broadcast circuitry 330 receives DSB response 196. Broadcast circuitry 330, in various embodiments, collects DSB responses 196 from all subsystems 150 that received DSB request 195 before broadcast circuitry 330 issues a single DSB response 196 to the issuer of DSB request 195 (e.g., a processor 145).

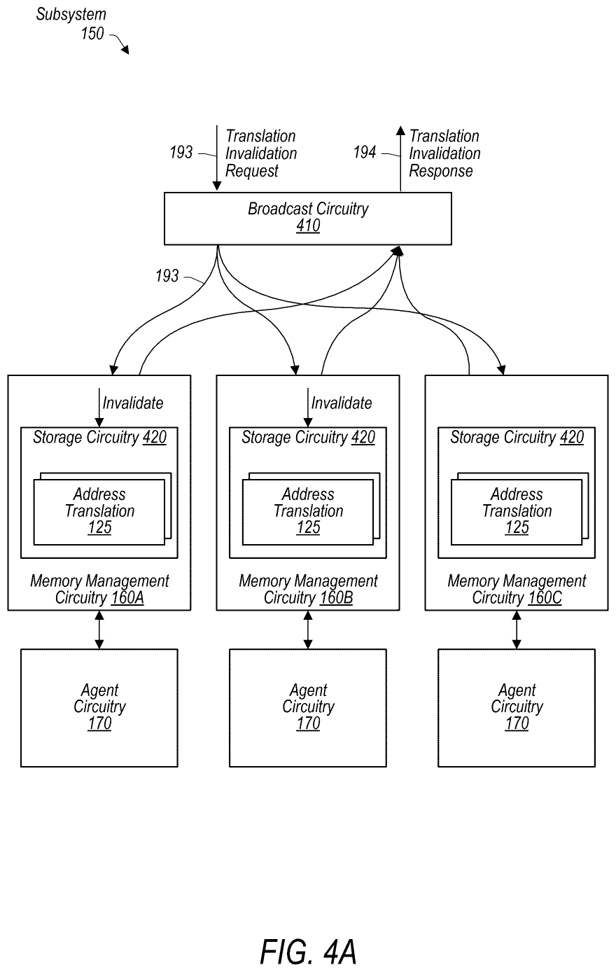

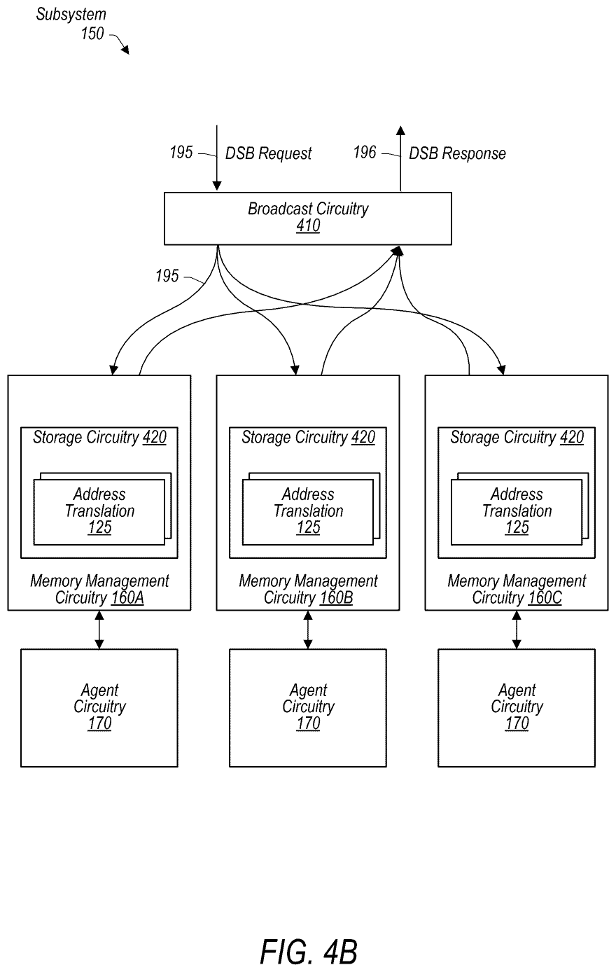

Turning now to FIG. 4A, a block diagram of one embodiment of a subsystem 150 having broadcast circuitry 410 that broadcasts a translation invalidation request 193 to the subsystem's memory management circuitry 160 is shown. In the illustrated embodiment, subsystem 150 includes memory management circuitry 160A-C, agent circuitry 170, and broadcast circuitry 410. As further shown, memory management circuitry 160A-C each include respective storage circuitry 420. The illustrated embodiment may be implemented differently than shown—e.g., if subsystem 150 includes only instance of memory management circuitry 160, then subsystem 150 may not include broadcast circuitry 410.

Broadcast circuitry 410, in various embodiments, includes circuitry that is configured to broadcast a translation invalidation request 193 to the memory management circuitry 160 of subsystem 150. As shown, broadcast circuitry 410 broadcasts a translation invalidation request 193 to memory management circuitry 160A-C. In some embodiments, broadcast circuitry 410 may broadcast the translation invalidation request 193 to only a subset of memory management circuitry 160A-C (e.g., to only memory management circuitry 160A). Broadcast circuitry 410 may track responses from memory management circuitry 160A-C that indicate completion of the invalidation request 193. In some embodiments, after responses to the invalidation request 193 have been received from memory management circuitry 160A-C, broadcast circuitry 410 issues, to invalidation management circuitry 185, a translation invalidation response 194 that indicates that the translation invalidation request 193 has been completed for subsystem 150. But in some embodiments, broadcast circuitry 410 issues the translation invalidation response 194 to invalidation management circuitry 185 without waiting for the responses from memory management circuitry 160A-C. In particular, broadcast circuitry 410 may issue the invalidation response 194 to invalidation management circuitry 185 upon receiving the invalidation request 193 from invalidation management circuitry 185—that is, a completion acknowledgement may be issued almost immediately.

In various embodiments, in response to receiving a translation invalidation request 193 from broadcast circuitry 410, memory management circuitry 160A-C initially determine if the translation invalidation request 193 is relevant to the address translations 125 cached in their storage circuitry 420. Storage circuitry 420, in various embodiments, is a translation lookaside buffer configured to cache address translations 125 (entries of page tables 120) in association with virtual addresses (particularly, their virtual page numbers). Accordingly, a virtual address may be used to access the associated address translation 125 (e.g., to obtain the physical page number to form the physical address). But in some cases, storage circuitry 420 caches address translations 125 without virtual addresses.

In order to determine if the received translation invalidation request 193 is relevant its cached address translations 125, in various embodiments, memory management circuitry 160 compares an address space identifier included in the invalidation request 193 against an address space identified stored in a local register. If they do not match, then that memory management circuitry 160 returns a response to broadcast circuitry 410 without performing any invalidation operations. As depicted, for example, memory management circuitry 160C returns a response without performing any invalidation operations (no invalidate is depicted). But if the address space identifiers match, then the memory management circuitry 160 invalidates cached address translations 125 based on translation invalidation payload 315 (e.g., a set of virtual addresses) of the invalidation request 193 and provides a response to broadcast circuitry 410. As shown, memory management circuitry 160A and 160B invalidate a set of address translations 125 that is cached in their storage circuitry 420.

Turning now to FIG. 4B, a block diagram of one embodiment of broadcast circuitry 410 broadcasting a DSB request 195 to a subsystem's memory management circuitry 160 is shown. The illustrated subsystem 150 includes memory management circuitry 160A-C, agent circuitry 170, and broadcast circuitry 410. Also as shown, memory management circuitry 160A-C each include storage circuitry 420.

In various embodiments, broadcast circuitry 410 further includes circuitry configured to broadcast a DSB request 195 (that is received from invalidation management circuitry 185) to the memory management circuitry 160 of subsystem 150. As shown, broadcast circuitry 410 broadcasts the DSB request 195 to memory management circuitry 160A-C. After receiving the DSB request 195, in various embodiments, memory management circuitry 160A-C ensure that any in-flight transactions, which may have used address translations 125 invalidated as a result of invalidation requests 193, have completed or are otherwise no longer in-flight. Once those in-flight transactions have completed, then memory management circuitry 160A-C may return responses to broadcast circuitry 410 to indicate completion of the DSB request 195. In various embodiments, after all the responses to the DSB request 195 have been received from memory management circuitry 160A-C, broadcast circuitry 410 issues, to invalidation management circuitry 185, a DSB response 196 that indicates that the DSB request 195 has been completed for subsystem 150.

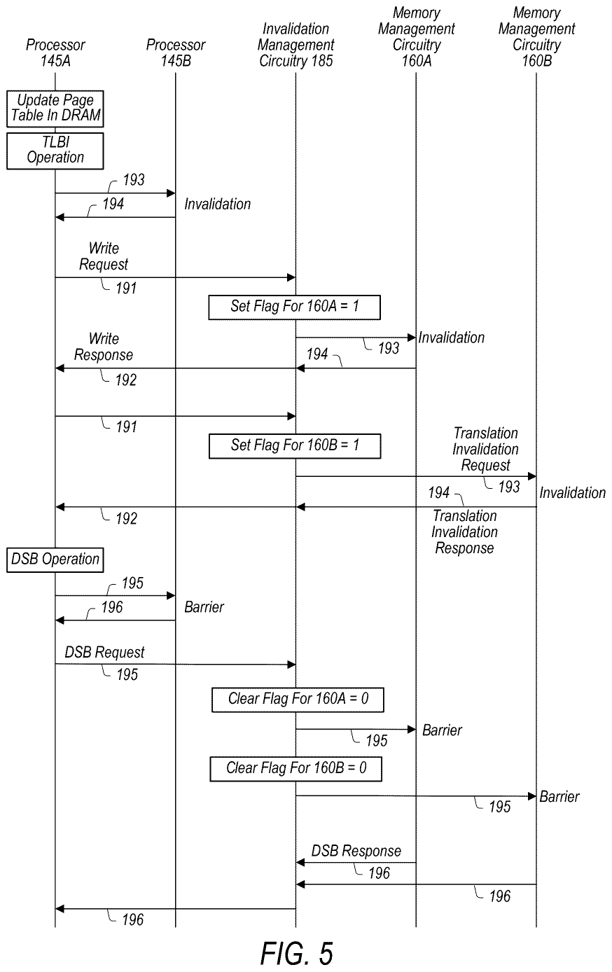

Turning now to FIG. 5, a block diagram of one embodiment of a process that involves invalidating cached address translations 125 is shown. In the illustrated embodiment, there are processors 145A and 145B, invalidation management circuitry 185, and memory management circuitry 160A and 160B that participate in the illustrated process. As shown, this process starts with processor 145A updating a page table 120 in DRAM. For example, processor 145A may update the page table 120 to transfer ownership of a physical memory page of the DRAM (e.g., from one process to another process). After updating the page table 120, processor 145A then initiates multiple TLBI operations to invalidate cached address translations 125 affected by the update to the page table 120.

Accordingly, as shown, processor 145A sends a translation invalidation request 193 to processor 145B to invalidate cached address translations 125 affected by the update to the page table 120. Processor 145B invalidates any relevant cached address translations 125 and returns a translation invalidation response 194, completing the transaction. Processor 145A also sends a write request 191 that is directed at memory management circuitry 160A to invalidate cached address translations 125 affected by the page table update. As shown, the write request 191 is intercepted by invalidation management circuitry 185. Invalidation management circuitry 185 then converts that write request 191 into an invalidation request 193, sets the invalidation flag 360 associated with memory management circuitry 160A (particularly, its subsystem 150), and issues the invalidation request 193. Memory management circuitry 160A receives the request 193 and invalidates any relevant cached address translations 125. An invalidation response 194 is returned to invalidation management circuitry 185, and invalidation management circuitry 185 converts it into a write response 192, which is returned to processor 145A.

Processor 145A also sends a write request 191 that is directed at memory management circuitry 160B to invalidate cached address translations 125 affected by the page table update. A similar process takes place. The write request 191 is intercepted by invalidation management circuitry 185. Invalidation management circuitry 185 then converts that write request 191 into an invalidation request 193, sets the invalidation flag 360 associated with memory management circuitry 160B, and issues the invalidation request 193. Memory management circuitry 160B receives that request 193 and invalidates any relevant cached address translations 125, and an invalidation response 194 is returned to invalidation management circuitry 185. Invalidation management circuitry 185 converts it into a write response 192, which is returned to processor 145A.

After the cached address translations 125 affected by the page table update have been invalidated, processor 145A initiates a DSB operation. Accordingly, processor 145A issues a DSB request 195 to processor 145B. Processor 145B performs the DSB operation and returns a DSB response to processor 145A, completing the transaction for processor 145B. Processor 145A further issues a DSB request 195 that is intercepted by invalidation management circuitry 185. Invalidation management circuitry 185 then broadcasts the DSB request 195 to memory management circuitry 160A and 160B (based on their associated invalidation flags 360 being set) and clears the invalidation flags 360. Memory management circuitry 160A and 160B then receive the DSB requests 195 and perform the DSB operation. DSB responses 196 are returned to invalidation management circuitry 185, completing the transactions for circuitry 160A and 160B. As shown, after receiving DSB responses 196 to all the DSB requests 195, invalidation management circuitry 185 provides a single DSB response 196 to processor 145A, completing the transaction.

Steps in the illustrated process may be performed differently than they are shown. For example, processor 145A may issue write requests 191 to memory management circuitry 160A and 160B at relatively the same time/in parallel, as opposed to waiting for a write response 192 to one write request 191 before issuing another write request 191. Furthermore, the invalidation request and the DSB request sent from processor 145A to processor 145B may be of a different type than the translation invalidation requests 193 and the DSB requests 195 that are received by memory management circuitry 160A and 160B.

Turning now to FIG. 6, a block diagram of one embodiment of power detection circuitry 620 that responds on behalf of a subsystem 150 is shown. In the illustrated embodiment, there is CPU complex 140, communication fabric 180, and power management circuitry 610 (PMGR 610). As shown, communication fabric 180 includes networks switches 210 that are coupled to network interfaces 220. As further shown, the network interface 220 that is coupled to CPU complex 140 includes invalidation management circuitry 185, and one of the network switches 210 includes power detection circuitry 620. The illustrated embodiment may be implemented differently than shown. For example, power detection circuitry 620 may be located elsewhere (e.g., within a network interface 220) and/or there may be multiple instances of power detection circuitry 620 located throughout communication fabric 180.

PMGR 610, in various embodiments, includes circuitry that is configured to generate SOC clocks, reset, and interrupts and control the supply voltage magnitudes. PMGR 610 may be under direct software control (e.g., software may directly request the power up and/or power down of components of SOC 105) and/or may be configured to monitor SOC 105 to determine when various components are to be powered up/down. In various embodiments, PMGR 610 is configured to manage a set of phase lock loops, voltage scaling mechanisms, rest control, and temperature sensor interfaces. PMGR 610 may also include circuitry that is configured to orchestrate performance-related adjustments of system components. A portion of PMGR 610 may be powered on during certain power performance states of system 100 but powered off during other performance states. In various embodiments, PMGR 610 includes an always-on component (AON) having circuitry configured to transition system 100 through performance states. Since there may be one or more performance states in which SOC 105 is powered off except for an AON power domain, this component may reside within that domain so that it can orchestrate power state transitions during those states. In order to perform power management, the AON component may implement hardcoded logic (e.g., state machines), circuitry that is configured to executes instructions (e.g., firmware or software instructions), or a combination of these.

In various embodiments, PMGR 610 is configured to power up/down subsystems 150 of SOC 105. As part of powering down a subsystem 150 (or components of the subsystem 150 such as its memory management circuitry 160), PMGR 610 may perform a handshake in which PMGR 610 ensures that the memory management circuitry 160 of the subsystem 150 satisfies the requirements of any invalidation requests 193 or DSB requests 195 directed to it. As part of the handshake, in various embodiments, the subsystem's memory management circuitry 160 invalidates or otherwise clears any cached address translations 125. As a result, invalidation requests 193 directed to the memory management circuitry 160 will be satisfied as the address translations 125 targeted by those invalidation requests 193 have been invalidated. After this handshake has been completed, PMGR 610 may then put that memory management circuitry 160 in reset, static clock, power gate it, or force no access.

Power detection circuitry 620, in various embodiments, includes circuitry configured to detect whether the illustrated subsystem 150 is powered down and respond, on its behalf, to translation invalidation requests 193 and DSB requests 195 if it is powered down. In particular, in various embodiments, a response must be provided to a translation invalidation request 193 and a DSB request 195. If the illustrated subsystem 150 is powered down, it may not respond without being powered up. Because no address translations 125 are cached by the subsystem's memory management circuitry 160 as a result of the handshake discussed above, powering up subsystem 150 to respond wastes system resources (e.g., power). Power detection circuitry 620 monitors whether subsystem 150 (or its memory management circuitry 160) is powered up or powered down. In the case that it is powered down, power detection circuitry 620 may respond on behalf of subsystem 150 to translation invalidation requests 193 and DSB requests 195. As such, power detection circuitry 620 may issue invalidation responses 194 and DSB responses 196 to invalidation management circuitry 185 indicating that the invalidation requests 193 and DSB requests 195 have been completed for subsystem 150—that is, power detection circuitry 620 may auto-acknowledge back to invalidation management circuitry 185, indicating that the requests were successfully completed. Power detection circuitry 620 can respond as such since the shutdown handshake (discussed above) guarantees that the memory management circuitry 160's cache is guaranteed to be invalid in the case of invalidation requests 193 and the memory management circuitry 160 has no transactions in flight in the case of DSB requests 195.

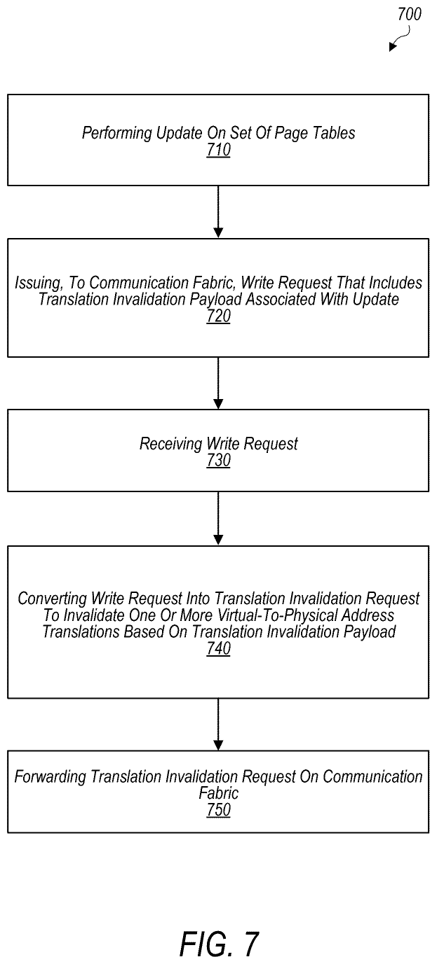

Turning now to FIG. 7, a flow diagram of a method 700 is shown. Method 700 is one embodiment of a method performed by a system (e.g., system 100) to invalidate a set of virtual-to-physical address translations (e.g., address translations 125). Method 700 may include more or fewer steps than shown. For example, method 700 may include a step in which the system broadcasts a DSB request (e.g., a DSB request 195).

Method 700 begins in step 710 with the system performing an update on a set of page tables (e.g., a set of page tables 120). In various embodiments, the system includes a processor complex (e.g., CPU complex 140), a plurality of subsystems (e.g., subsystems 150A-C), and a communication fabric (e.g., communication fabric 180) coupled to the processor complex and the plurality of subsystems. The processor complex includes one or more processor cores (e.g., processors 145) configured to execute program instructions. Also, a given one of the plurality of subsystems may include a respective set of memory management circuits (e.g., memory management circuitry 160), and a given one of that set of memory management circuits may be configured to cache one or more of a plurality of virtual-to-physical address translations of the set of page tables. In various embodiments, step 710 is performed by a particular processor core of the processor complex.

In step 720, the system issues, to the communication fabric, a write request (e.g., a write request 191) that includes a translation invalidation payload that is associated with the update. In various embodiments, step 720 is performed by the particular processor core. In step 730, the communication fabric receives the write request. In various embodiments, the fabric includes a first fabric circuit (e.g., invalidation management circuitry 185) and the write request is received by the first fabric circuit. The first fabric circuit may be configured to be powered on while the one or more processor cores are powered on.

In step 740, the system converts the write request into a translation invalidation request (e.g., a translation invalidation request 193) to invalidate one or more virtual-to-physical address translations based on the translation invalidation payload. In various embodiments, step 740 is performed by the first fabric circuit. The translation invalidation request may target one or more of the plurality of subsystems. In some embodiments, the write request identifies a set of addresses in a particular address space (e.g., address offsets 312 in the address space). The first fabric circuit may store a mapping between addresses in the particular address space and ones of the plurality of subsystems and identify the one or more subsystems to target with the translation invalidation request based on the stored mapping and the set of addresses identified in the write request. In some embodiments, the addresses in the mapping are mapped to destination identifiers (e.g., destination IDs 350) associated with the subsystems. The translation invalidation request may specify one or more destination identifiers corresponding to the one or more subsystems instead of the set of addresses. In step 750, the system forwards the translation invalidation request on the communication fabric. In various embodiments, step 740 is performed by the first fabric circuit.

In various embodiments, a particular one of the one or more subsystems is configured to receive the translation invalidation request and broadcast the translation invalidation request to the set of memory management circuits of the particular subsystem. A particular one of the memory management circuits may be configured to receive the translation invalidation request and detect whether the translation invalidation request is relevant to virtual-to-physical address translations cached by the particular memory management circuit. In response to a detection that the translation invalidation request is relevant, the particular memory management circuit may perform an invalidation operation based on the one or more virtual-to-physical address translations and issue a response to the translation invalidation request—one or more cached virtual-to-physical address translation may be invalidated. But in response to a detection that the translation invalidation request is not relevant, the particular memory management circuit may issue a response to the translation invalidation request without performing the invalidation operation—no cached address translation may be invalidated. The particular subsystem may issue a translation invalidation response (e.g., a translation invalidation response 194) to the first fabric circuit that indicates that the translation invalidation request has been completed by the particular subsystem. In some cases, the translation invalidation response may be issued by the particular subsystem after responses to the translation invalidation request have been received from the set of management circuits of the particular subsystem.

In various embodiments, the particular processor core of the processor complex is configured to issue a DSB request (e.g., a DSB request 195). The first fabric circuit may be configured to receive the DSB request, broadcast the DSB request to a set of subsystems of the plurality of subsystems, and then issue a DSB response (e.g., a DSB response 196) to the particular processor core after responses to the DSB request have been received that indicate the DSB request has been completed for those subsystems. In some embodiments, the first fabric circuit is configured to track the particular ones of the plurality of subsystems that received at least one translation invalidation request (since a previous DSB request was issued by the one or more processor cores of the processor complex) and issue the received DSB request to only those particular subsystems. In some embodiments, the first fabric circuit is configured to, in response to a detection that none of the plurality of subsystems have received a translation invalidation request since the previous DSB request, issue, without broadcasting the received DSB request, a DSB response to the particular processor core. In some embodiments, the communication fabric includes a second fabric circuit (e.g., power detection circuitry 620) that is configured to detect whether a particular one of the one or more subsystems is powered on, receive the DSB request from the first fabric circuit, and in response to a detection that the particular subsystem is powered down, issue a DSB response to the first fabric circuit that indicates that the DSB request has been completed.

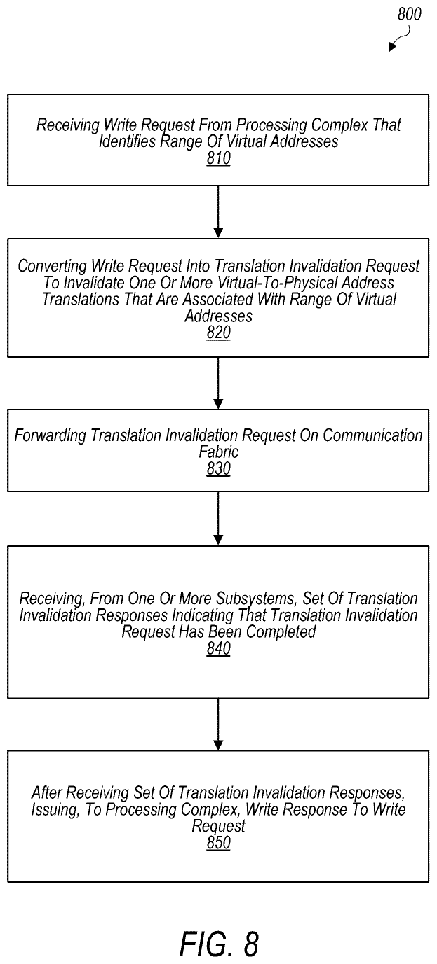

Turning now to FIG. 8, a flow diagram of a method 800 is shown. Method 800 is one embodiment of a method performed by a fabric circuit (e.g., invalidation management circuitry 185) of a communication fabric (e.g., communication fabric 180) to invalidate a set of virtual-to-physical address translations (e.g., address translations 125). Method 800 may include more or fewer steps than shown. For example, method 800 may include a step in which the fabric circuit broadcasts a DSB request (e.g., a DSB request 195).

Method 800 begins in step 810 with the fabric circuit receiving a write request (e.g., a write request 191) from a particular processor core (e.g., a processor 145) that identifies a range of virtual addresses. In step 820, the fabric circuit converts the write request into a translation invalidation request (e.g., a translation invalidation request 193) to invalidate one or more virtual-to-physical address translations that are associated with the range of virtual addresses. The translation invalidation may request targets one or more of a plurality of subsystems (e.g., subsystems 150). A given one of the plurality of subsystems may be configured to cache one or more of a plurality of virtual-to-physical address translations of a set of page tables (e.g., a set of page tables 120). In step 830, the fabric circuit forwards the translation invalidation request on the communication fabric.

A particular one of the one or more subsystems may receive the translation invalidation request and broadcast the translation invalidation request to a plurality of memory management circuits (e.g., memory management circuitry 160) in the particular subsystem. A given one of the plurality of memory management circuits may be configured to cache ones of the plurality of virtual-to-physical address translations of the page tables. After responses to the translation invalidation request have been received from the plurality of memory management circuits, the particular subsystem may issue a translation invalidation response (e.g., a translation invalidation response 194) to the fabric circuit that indicates that the translation invalidation request has been completed by the particular subsystem. In some embodiments, another fabric circuit of the communication fabric receives the translation invalidation request and detects whether a particular one of the one or more subsystems is powered on. In response to detecting that the particular subsystem is powered down, this other fabric circuit may issue a translation invalidation response to the former fabric circuit that indicates that the translation invalidation request has been completed for the particular subsystem.

In step 840, the fabric circuit receives, from the one or more subsystems, translation invalidation responses indicating that the translation invalidation request has been completed. In step 850, after receiving the set of translation invalidation responses, the fabric circuit issues, to the particular processor core, a write response (e.g., a write response 192) to the write request. After issuing the write response to the particular processor core, the fabric circuit may receive, from the particular processor core, a DSB request (e.g., a DSB request 195). In various embodiments, the fabric circuit broadcasts the DSB request to the one or more subsystems and issues a DSB response (e.g., a DSB response 196) to the particular processor core after receiving responses to the DSB request that indicate that the DSB request has been completed for the one or more subsystems. In some embodiments, the fabric circuit tracks which particular ones of the plurality of subsystems have received at least one translation invalidation request since a previous DSB request issued by the particular processor core and issues the DSB request to only those particular subsystems.

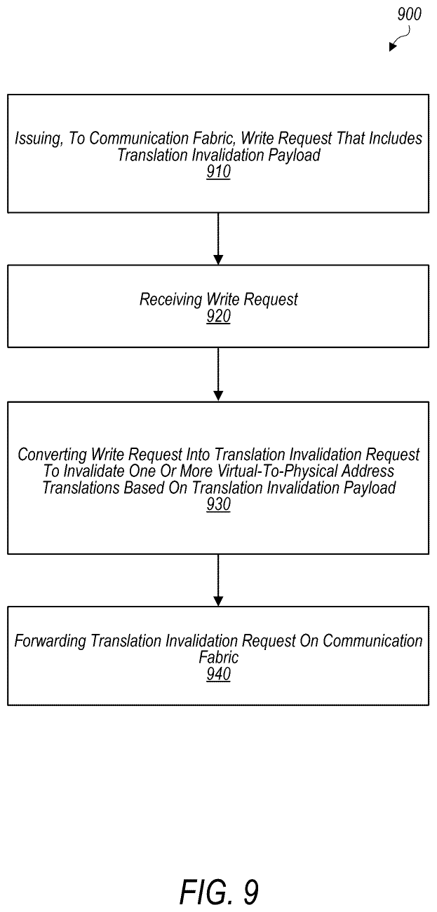

Turning now to FIG. 9, a flow diagram of a method 900 is shown. Method 900 is one embodiment of a method performed by a system (e.g., system 100) to invalidate a set of virtual-to-physical address translations (e.g., address translations 125). Method 900 may include more or fewer steps than shown. For example, method 900 may include a step in which the system broadcasts a DSB request (e.g., a DSB request 195).

Method 900 begins in step 910 with the system issuing, to a communication fabric (e.g., communication fabric 180) of the system, a write request (e.g., a write request 191) having a translation invalidation payload. In various embodiments, the system includes a processor complex (e.g., CPU complex 140), a plurality of memory management circuits (e.g., memory management circuitry 160A-D), and the communication fabric that is coupled to the processor complex and the plurality of memory management circuits and further configured to facilitate communication between the processor complex and the memory management circuits. A given one of the plurality of memory management circuits may be configured to cache one or more of a plurality of virtual-to-physical address translations (e.g., address translations 125) of a set of page tables (e.g., a set of page tables 120). In various embodiments, step 910 is performed by the processor complex (particularly, by a processor core of the processor complex) of the system.

In step 920, the communication fabric receives the write request. A first fabric circuit (e.g., invalidation management circuitry 185) of the communication fabric may receive the write request. In various embodiments, the communication fabric comprises a plurality of network interface circuits (e.g., network interfaces 220) coupled to a plurality of switches (e.g., network switches 210). A particular network interface circuit that is coupled to the processor complex may include the first fabric circuit. In step 930, the first fabric circuit converts the write request into a translation invalidation request (e.g., a translation invalidation request 193) to invalidate one or more virtual-to-physical address translations based on the translation invalidation payload. The translation invalidation request may target one or more of the plurality of memory management circuits.

In step 940, the first fabric circuit forwards the translation invalidation request on the communication fabric. In some embodiments, the communication fabric includes a second fabric circuit that is configured to detect whether a particular one of the one or more memory management circuits is powered on, receive the translation invalidation request from the first fabric circuit, and in response to a detection that the particular memory management circuit is powered down, issue a translation invalidation response to the first fabric circuit that indicates that the translation invalidation request has been completed.

The processor complex (particularly, by a processor core of the processor complex) may be configured to issue a first DSB request, and the first fabric circuit may be configured to receive the DSB request, broadcast it to particular ones of the plurality of memory management circuits, and then issue a DSB response to the processor complex after responses to the DSB requests have been received that indicate that the DSB request has been completed by the particular memory management circuits. The processor complex may include a first processor core (e.g., a processor 145) that is configured to issue the first DSB request and a second processor core (e.g., a processor 145) that is configured to issue a second DSB request. In various embodiments, the first fabric circuit is configured to issue, to the first and second processor cores, DSB responses to the first and second DSB requests in an order in which the first and second DSB requests are received by the first fabric circuit.

### Example Device

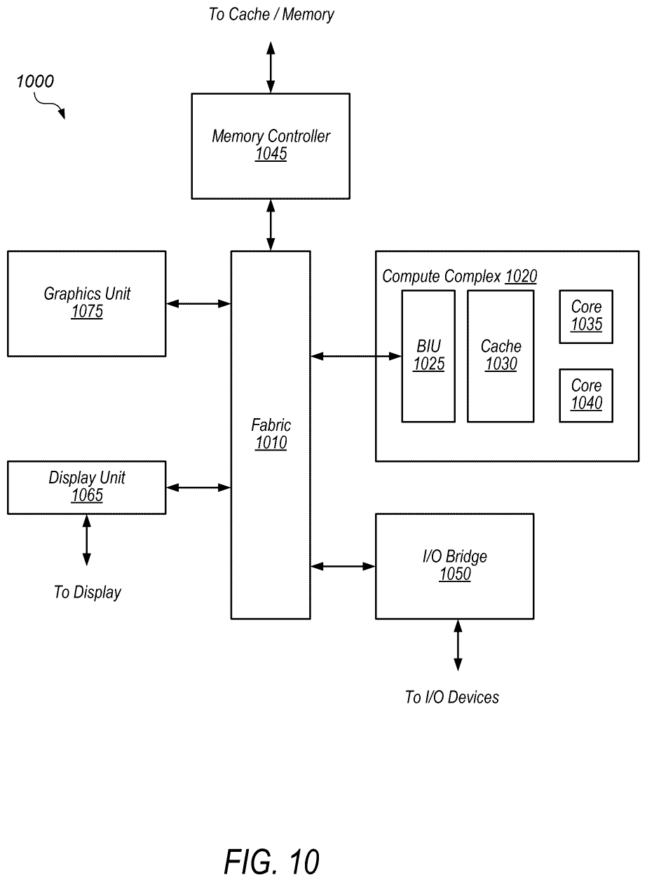

Referring now to FIG. 10, a block diagram illustrating an example embodiment of a device 1000 is shown. In various embodiments, device 1000 implements system 100 and/or it may implement the functionality of circuitry shown in FIGS. 1-4 and 6. In some embodiments, elements of device 1000 may be included within a system on a chip (e.g., SOC 105). In some embodiments, device 1000 may be included in a mobile device that may be battery-powered. Therefore, power consumption by device 1000 may be an important design consideration. In the illustrated embodiment, device 1000 includes a fabric 1010, a compute complex 1020 an input/output (I/O) bridge 1050, a cache/memory controller 1045, a graphics unit 1075, and a display unit 1065. Graphics unit 1075, display unit 1065, and I/O bridge 1050 may each be a subsystem 150. In some embodiments, device 1000 may include other components (not shown) in addition to or in place of the illustrated components, such as video processor encoders and decoders, image processing or recognition elements, computer vision elements, etc.

Fabric 1010 may include various interconnects, buses, MUX's, controllers, etc., and may be configured to facilitate communication between various elements of device 1000. In some embodiments, portions of fabric 1010 may be configured to implement various different communication protocols. In other embodiments, fabric 1010 may implement a single communication protocol and elements coupled to fabric 1010 may convert from the single communication protocol to other communication protocols internally.

In the illustrated embodiment, compute complex 1020 includes bus interface unit (BIU) 1025, cache 1030, and cores 1035 and 1040. In various embodiments, compute complex 1020 may include various numbers of processors, processor cores and caches. For example, compute complex 1020 may include 1, 2, or 4 processor cores, or any other suitable number. In one embodiment, cache 1030 is a set associative L2 cache. In some embodiments, cores 1035 and 1040 may include internal instruction and data caches. In some embodiments, a coherency unit (not shown) in fabric 1010, cache 1030, or elsewhere in device 1000 may be configured to maintain coherency between various caches of device 1000. BIU 1025 may be configured to manage communication between compute complex 1020 and other elements of device 1000. Processor cores such as cores 1035 and 1040 may be configured to execute instructions of a particular instruction set architecture (ISA) which may include operating system instructions and user application instructions. These instructions may be stored in computer readable medium such as a memory coupled to memory controller 1045 discussed below.

As used herein, the term “coupled to” may indicate one or more connections between elements, and a coupling may include intervening elements. For example, in FIG. 10, graphics unit 1075 may be described as “coupled to” a memory through fabric 1010 and cache/memory controller 1045. In contrast, in the illustrated embodiment of FIG. 10, graphics unit 1075 is “directly coupled” to fabric 1010 because there are no intervening elements.

Cache/memory controller 1045 may be configured to manage transfer of data between fabric 1010 and one or more caches and memories. For example, cache/memory controller 1045 may be coupled to an L3 cache, which may in turn be coupled to a system memory. In other embodiments, cache/memory controller 1045 may be directly coupled to a memory. In some embodiments, cache/memory controller 1045 may include one or more internal caches. Memory coupled to controller 1045 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 1045 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 1020 to cause the computing device to perform functionality described herein.

Graphics unit 1075 may include one or more processors, e.g., one or more graphics processing units (GPUs). Graphics unit 1075 may receive graphics-oriented instructions, such as OPENGL®, Metal®, or DIRECT3D® instructions, for example. Graphics unit 1075 may execute specialized GPU instructions or perform other operations based on the received graphics-oriented instructions. Graphics unit 1075 may generally be configured to process large blocks of data in parallel and may build images in a frame buffer for output to a display, which may be included in the device or may be a separate device. Graphics unit 1075 may include transform, lighting, triangle, and rendering engines in one or more graphics processing pipelines. Graphics unit 1075 may output pixel information for display images. Graphics unit 1075, in various embodiments, may include programmable shader circuitry which may include highly parallel execution cores configured to execute graphics programs, which may include pixel tasks, vertex tasks, and compute tasks (which may or may not be graphics-related).

Display unit 1065 may be configured to read data from a frame buffer and provide a stream of pixel values for display. Display unit 1065 may be configured as a display pipeline in some embodiments. Additionally, display unit 1065 may be configured to blend multiple frames to produce an output frame. Further, display unit 1065 may include one or more interfaces (e.g., MIPI® or embedded display port (eDP)) for coupling to a user display (e.g., a touchscreen or an external display).

I/O bridge 1050 may include various elements configured to implement: universal serial bus (USB) communications, security, audio, and low-power always-on functionality, for example. I/O bridge 1050 may also include interfaces such as pulse-width modulation (PWM), general-purpose input/output (GPIO), serial peripheral interface (SPI), and inter-integrated circuit (I2C), for example. Various types of peripherals and devices may be coupled to device 1000 via I/O bridge 1050.

In some embodiments, device 1000 includes network interface circuitry (not explicitly shown), which may be connected to fabric 1010 or I/O bridge 1050. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1000 with connectivity to various types of other devices and networks.

### Example Applications

Turning now to FIG. 11, various types of systems that may include any of the circuits, devices, or system discussed above. System or device 1100, which may incorporate or otherwise utilize one or more of the techniques described herein, may be utilized in a wide range of areas. For example, system or device 1100 may be utilized as part of the hardware of systems such as a desktop computer 1110, laptop computer 1120, tablet computer 1130, cellular or mobile phone 1140, or television 1150 (or set-top box coupled to a television).

Similarly, disclosed elements may be utilized in a wearable device 1160, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1100 may also be used in various other contexts. For example, system or device 1100 may be utilized in the context of a server computer system, such as a dedicated server or on shared hardware that implements a cloud-based service 1170. Still further, system or device 1100 may be implemented in a wide range of specialized everyday devices, including devices 1180 commonly found in the home such as refrigerators, thermostats, security cameras, etc. The interconnection of such devices is often referred to as the “Internet of Things” (IoT). Elements may also be implemented in various modes of transportation. For example, system or device 1100 could be employed in the control systems, guidance systems, entertainment systems, etc. of various types of vehicles 1190.

The applications illustrated in FIG. 11 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

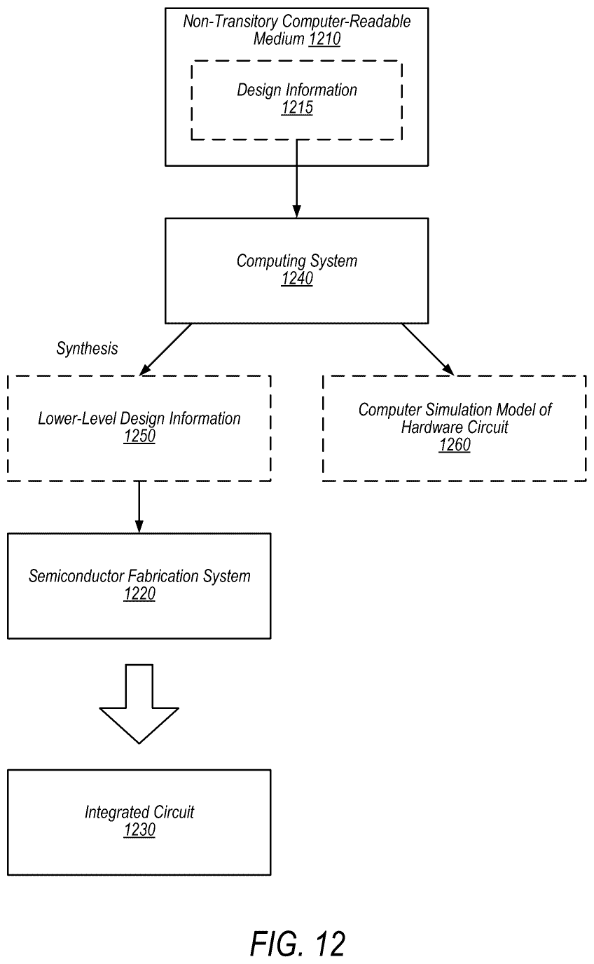

FIG. 12 is a block diagram illustrating an example non-transitory computer-readable storage medium that stores circuit design information, according to some embodiments. In the illustrated embodiment, computing system 1240 is configured to process the design information. This may include executing instructions included in the design information, interpreting instructions included in the design information, compiling, transforming, or otherwise updating the design information, etc. Therefore, the design information controls computing system 1240 (e.g., by programming computing system 1240) to perform various operations discussed below, in some embodiments.

In the illustrated example, computing system 1240 processes the design information to generate both a computer simulation model of a hardware circuit 1260 and lower-level design information 1250. In other embodiments, computing system 1240 may generate only one of these outputs, may generate other outputs based on the design information, or both. Regarding the computing simulation, computing system 1240 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1240 also processes the design information to generate lower-level design information 1250 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1250 (potentially among other inputs), semiconductor fabrication system 1220 is configured to fabricate an integrated circuit 1230 (which may correspond to functionality of the simulation model 1260). Note that computing system 1240 may generate different simulation models based on design information at various levels of description, including information 1250, 1215, and so on. The data representing design information 1250 and model 1260 may be stored on medium 1210 or on one or more other media.

In some embodiments, the lower-level design information 1250 controls (e.g., programs) the semiconductor fabrication system 1220 to fabricate the integrated circuit 1230. Thus, when processed by the fabrication system, the design information may program the fabrication system to fabricate a circuit that includes various circuitry disclosed herein.

Non-transitory computer-readable storage medium 1210, may comprise any of various appropriate types of memory devices or storage devices. Non-transitory computer-readable storage medium 1210 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1210 may include other types of non-transitory memory as well or combinations thereof. Accordingly, non-transitory computer-readable storage medium 1210 may include two or more memory media; such media may reside in different locations—for example, in different computer systems that are connected over a network.

Design information 1215 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 1240, semiconductor fabrication system 1220, or both. In some embodiments, design information may also include one or more cell libraries that specify the synthesis, layout, or both of integrated circuit 1230. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1230 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1220 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1220 may also be configured to perform various testing of fabricated circuits for correct operation.

In various embodiments, integrated circuit 1230 and model 1260 are configured to operate according to a circuit design specified by design information 1215, which may include performing any of the functionality described herein. For example, integrated circuit 1230 may include any of various elements shown in FIGS. 1-5 and 6. Further, integrated circuit 1230 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1220 to fabricate integrated circuit 1230.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. A system, comprising:
a processor complex that includes one or more processor cores;
a plurality of subsystems, wherein a given subsystem of the plurality of subsystems includes a respective set of memory management circuits, and wherein a given memory management circuit of the respective set of memory management circuits is configured to cache one or more of a plurality of virtual-to-physical address translations of a set of page tables; and
a communication fabric coupled to the one or more processor cores and the plurality of subsystems and is configured to facilitate communication between the one or more processor cores and the plurality of subsystems;
wherein a particular processor core of the one or more processor cores is further configured to:
perform an update on the set of page tables; and
issue, to the communication fabric, a write request that includes a translation invalidation payload associated with the update; and
wherein the communication fabric includes a first fabric circuit that is configured to:
receive the write request;
convert the write request into a translation invalidation request to invalidate, based on the translation invalidation payload, one or more virtual-to-physical address translations, wherein the translation invalidation request targets one or more subsystems of the plurality of subsystems; and
forward the translation invalidation request on the communication fabric.

2. The system of claim 1, wherein a particular subsystem of the one or more subsystems is configured to:
receive the translation invalidation request;
broadcast the translation invalidation request to a set of memory management circuits of the particular subsystem; and
issue a translation invalidation response, to the first fabric circuit, that indicates that the translation invalidation request has been completed by the particular subsystem.

3. The system of claim 2, wherein a particular memory management circuit of the set of memory management circuits of the particular subsystem is configured to:
receive the translation invalidation request;
detect whether the translation invalidation request is relevant to virtual-to-physical address translations cached by the particular memory management circuit;
in response to a detection that the translation invalidation request is relevant, i) perform an invalidation operation on the virtual-to-physical address translations and ii) issue a response to the translation invalidation request; and
in response to a detection that the translation invalidation request is not relevant, issue a response to the translation invalidation request without performing the invalidation operation.

4. The system of claim 1, wherein the particular processor core is configured to issue a data synchronization barrier (DSB) request, and wherein the first fabric circuit is configured to:
receive the DSB request;
broadcast the DSB request to a set of subsystems of the plurality of subsystems; and
issue a DSB response, to the particular processor core after responses to the DSB request have been received, that indicates that the DSB request has been completed by the set of subsystems.

5. The system of claim 4, wherein the first fabric circuit is configured to:
track which particular subsystems of the plurality of subsystems have received at least one translation invalidation request since a previous DSB request was issued by the one or more processor cores; and
issue the received DSB request to only those particular subsystems.

6. The system of claim 4, wherein the communication fabric includes a second fabric circuit configured to:
detect whether a particular subsystem of the set of subsystems is powered on;
receive the DSB request from the first fabric circuit; and
in response to a detection that the particular subsystem is powered down, issue a DSB response, to the first fabric circuit, that indicates that the DSB request has been completed.

7. The system of claim 4, wherein the first fabric circuit is configured to:
in response to a detection that none of the plurality of subsystems have received a translation invalidation request since a previous DSB request was issued by the one or more processor cores, issue, without broadcasting the DSB request, a DSB response to the particular processor core.

8. The system of claim 1, wherein the write request identifies a set of addresses in a particular address space, and wherein the first fabric circuit is configured to:
store a mapping between addresses, in the particular address space, and the plurality of subsystems; and
identify, based on the stored mapping and the set of addresses identified in the write request, the one or more subsystems to target with the translation invalidation request.

9. The system of claim 8, wherein the addresses, in the stored mapping, are mapped to destination identifiers that are associated with the plurality of subsystems, and wherein the translation invalidation request specifies, instead of the set of addresses, one or more of the destination identifiers corresponding to the one or more subsystems.

10. The system of claim 1, wherein the first fabric circuit is configured to be powered on while the one or more processor cores are powered on.

11. A method, comprising:
receiving, by a first fabric circuit of a communication fabric that couples one or more processor cores to a plurality of subsystems, a write request from a particular processor core that identifies a range of virtual addresses, wherein a given subsystem of the plurality of subsystems is configured to cache one or more of a plurality of virtual-to-physical address translations of a set of page tables;
converting, by the first fabric circuit, the write request into a translation invalidation request to invalidate one or more virtual-to-physical address translations that are associated with the range of virtual addresses, wherein the translation invalidation request targets one or more subsystems of the plurality of subsystems;
forwarding, by the first fabric circuit, the translation invalidation request on the communication fabric;
receiving, by the first fabric circuit and from the one or more subsystems, a set of translation invalidation responses indicating that the translation invalidation request has been completed; and
after receiving the set of translation invalidation responses, the first fabric circuit issuing, to the particular processor core, a write response to the write request.

12. The method of claim 11, further comprising:
after issuing the write response to the particular processor core, the first fabric circuit receiving, from the particular processor core, a data synchronization barrier (DSB) request;
broadcasting, by the first fabric circuit, the DSB request to the one or more subsystems; and
issuing, by the first fabric circuit, a DSB response, to the particular processor core after receiving responses to the DSB request, that indicates that the DSB request has been completed by the one or more subsystems.

13. The method of claim 12, further comprising:
tracking, by the first fabric circuit, which particular subsystems of the plurality of subsystems have received at least one translation invalidation request since a previous DSB request issued by the one or more processor cores, wherein the DSB request is issued by the first fabric circuit to only those particular subsystems.

14. The method of claim 11, further comprising:
receiving, by a particular subsystem of the one or more subsystems, the translation invalidation request;
broadcasting, by the particular subsystem, the translation invalidation request to a plurality of memory management circuits within the particular subsystem, wherein a given memory management circuit of the plurality of memory management circuits is configured to cache one or more of the plurality of virtual-to-physical address translations; and
issuing, by the particular subsystem, a translation invalidation response, to the first fabric circuit, that indicates that the translation invalidation request has been completed by the particular subsystem.

15. The method of claim 11, further comprising:
receiving, by a second fabric circuit of the communication fabric, the translation invalidation request from the first fabric circuit;
detecting, by the second fabric circuit, whether a particular subsystem of the one or more subsystems is powered on; and
in response to detecting that the particular subsystem is powered down, the second fabric circuit issuing a translation invalidation response, to the first fabric circuit, that indicates that the translation invalidation request has been completed by the particular subsystem.

16. An apparatus, comprising:
a processor complex that includes one or more processor cores;
a plurality of memory management circuits located outside of the processor complex, wherein a given memory management circuit of the plurality of memory management circuits is configured to cache one or more of a plurality of virtual-to-physical address translations of a set of page tables; and
a communication fabric that is coupled to the one or more processor cores and the plurality of memory management circuits and is configured to facilitate communication between the one or more processor cores and the plurality of memory management circuits;
wherein a first processor core of the one or more processor cores is further configured to:
issue, to the communication fabric, a write request that includes a translation invalidation payload;
wherein the communication fabric includes a first fabric circuit that is configured to:
receive the write request;
convert the write request into a translation invalidation request to invalidate, based on the translation invalidation payload, one or more virtual-to-physical address translations, wherein the translation invalidation request targets one or more of the plurality of memory management circuits; and
forward the translation invalidation request on the communication fabric.

17. The apparatus of claim 16, wherein the first processor core is configured to issue a first data synchronization barrier (DSB) request and wherein the first fabric circuit is configured to:
receive the DSB request;
broadcast the DSB request to particular memory management circuits of the plurality of memory management circuits; and
issue a DSB response, to the first processor core after responses to the DSB request have been received, that indicates that the DSB request has been completed by the particular memory management circuits.

18. The apparatus of claim 17, wherein a second processor core of the one or more processor cores is configured to issue a second DSB request, and wherein the first fabric circuit is configured to:
issue, to the first and second processor cores, DSB responses to the first and second DSB requests in an order in which the first and second DSB requests are received by the first fabric circuit.

19. The apparatus of claim 16, wherein the communication fabric includes a second fabric circuit configured to:
detect whether a particular memory management circuit of the one or more memory management circuits is powered on;
receive the translation invalidation request from the first fabric circuit; and
in response to a detection that the particular memory management circuit is powered down, issue a translation invalidation response, to the first fabric circuit, that indicates that the translation invalidation request has been completed.

20. The apparatus of claim 16, wherein the communication fabric includes a plurality of network interface circuits coupled to a plurality of switches, and wherein the plurality of network interface circuits includes a particular network interface circuit that i) is coupled to the first processor core and ii) includes the first fabric circuit.
